(19) United States
(12) Patent Application Publication
(10) Pub. No.: US 2025/0002402 A1
(43) Pub. Date: Jan. 2, 2025

(54) ION EXCHANGEABLE GLASS-BASED ARTICLES HAVING HIGH FRACTURE TOUGHNESS

(71) Applicant: CORNING INCORPORATED, Corning, NY (US)

(72) Inventors: Michael Morris Clark, Wellsboro, PA (US); Jeffrey Alan Decker, Broomall, PA (US); Xiaoju Guo, Pittsford, NY (US); Zhenhua Guo, Painted Post, NY (US); Mathieu Gerard Jacques Hubert, Corning, NY (US); Peter Joseph Lezzi, Corning, NY (US); Pascale Oram, Painted Post, NY (US); Nicholas John Tostanoski, Painted Post, NY (US); Bin Zhu, Ithaca, NY (US)

(21) Appl. No.: 18/748,553

(22) Filed: Jun. 20, 2024

Related U.S. Application Data
(60) Provisional application No. 63/523,718, filed on Jun. 28, 2023.
(60) Provisional application No. 63/585,351, filed on Sep. 26, 2023.

(51) Int. Cl. C03C 21/00; C03C 3/097; H05K 5/03

(52) U.S. Cl. CPC C03C 21/002; C03C 3/097; H05K 5/03

(57) ABSTRACT

A glass composition can include from 60 mol % to 69 mol % SiO₂, from 10 mol % to 18 mol % Al₂O₃, from 2.3 mol % to 6.9 mol % Li₂O, from 2.1 mol % to 6.7 mol % Na₂O, and from 1.1 mol % to 9 mol % alkaline earth metal oxides. The glass composition can comprise a liquidus viscosity greater than or equal to 150 kP. The glass composition can include from 0.25 mol % to 1 mol % K₂O, from 0.5 mol % to 4 mol % P₂O₅, and/or 0.5 mol % to 3.6 mol % B₂O₃. The glass composition can form anorthoclase or a feldspar solid solution. The glass composition can include MgO+Li₂O−(CaO+SrO+Na₂O+K₂O) is from −0.5 to −4. The glass composition can include volume electrical resistivity is greater than or equal to 2×10¹⁵ Ohm-centimeters. The glass composition may have a fracture toughness of greater than or equal 0.75 MPa√m.

This application claims the benefit of priority under 35 U.S.C. § 119 of U.S. Provisional Application Ser. No. 63/523,718 filed on Jun. 28, 2023, and U.S. Provisional Application Ser. No. 63/585,351 filed on Sep. 26, 2023, the content of each is relied upon and incorporated herein by reference in their entirety.

### BACKGROUND

### Field

The present specification generally relates to glass-based compositions suitable for use as a cover glass for electronic devices. More specifically, the present specification is directed to ion exchangeable glass-based articles that may be formed into cover glass for electronic devices.

### Technical Background

The mobile nature of portable devices, such as smart phones, tablets, portable media players, personal computers, and cameras, makes these devices particularly vulnerable to accidental dropping on hard surfaces, such as the ground. These devices typically incorporate cover glasses, which may become damaged upon impact with hard surfaces. In many of these devices, the cover glasses function as display covers, and may incorporate touch functionality, such that use of the devices is negatively impacted when the cover glasses are damaged.

There are two major failure modes of cover glass when the associated portable device is dropped on a hard surface. One of the modes is flexure failure, which is caused by bending of the glass when the device is subjected to dynamic load from impact with the hard surface. The other mode is sharp contact failure, which is caused by introduction of damage to the glass surface. Impact of the glass with rough hard surfaces, such as asphalt, granite, etc., can result in sharp indentations in the glass surface. These indentations become failure sites in the glass surface from which cracks may develop and propagate.

Glass can be made more resistant to flexure failure by the ion-exchange technique, which involves inducing compressive stress in the glass surface. However, the ion-exchanged glass will still be vulnerable to dynamic sharp contact, owing to the high stress concentration caused by local indentations in the glass from the sharp contact.

It has been a continuous effort for glass makers and handheld device manufacturers to improve the resistance of handheld devices to sharp contact failure. Solutions range from coatings on the cover glass to bezels that prevent the cover glass from impacting the hard surface directly when the device drops on the hard surface. However, due to the constraints of aesthetic and functional requirements, it is very difficult to completely prevent the cover glass from impacting the hard surface.

It is also desirable that portable devices be as thin as possible. Accordingly, in addition to strength, it is also desired that glasses to be used as a cover glass in portable devices be made as thin as possible. Thus, in addition to increasing the strength of the cover glass, it is also desirable for the glass to have mechanical characteristics that allow it to be formed by processes that are capable of making thin glass-based articles, such as thin glass sheets.

Accordingly, a need exists for glasses that can be strengthened, such as by ion exchange, and that have the mechanical properties that allow them to be formed as thin glass-based articles.

### SUMMARY

There are set forth herein lithium aluminosilicate glasses with good ion exchangeability, good glass quality, and high fracture toughness. Chemical strengthening processes can be used to achieve high strength and high toughness properties in lithium aluminosilicate glasses. The substitution of Al₂O₃ into the silicate glass network increases the interdiffusivity of monovalent cations during ion exchange. By chemical strengthening in a molten salt bath (e.g., KNO₃ or NaNO₃), glasses with high strength, high toughness, and high indentation cracking resistance can be achieved. The stress profiles achieved through chemical strengthening may have a variety of shapes that increase the drop performance, strength, toughness, and other attributes of the glass-based articles.

The glasses described herein can achieve high fracture toughness values (e.g., at least 0.75 MPa√m) without the inclusion of additives, such as ZrO₂, Ta₂O₅, TiO₂, HfO₂, La₂O₃, and Y₂O₃, that increase the fracture toughness but are expensive and may have limited commercial availability. In this respect, the glasses disclosed herein provide comparable or improved performance with reduced manufacturing costs. Fracture toughness and stress at depth are critical for improved drop performance on rough surfaces. For this reason, maximizing the amount of stress that can be provided in a glass-based article before reaching a frangibility limit increases the stress at depth and the rough surface drop performance. The fracture toughness is known to control the frangibility limit and increasing the fracture toughness increases the frangibility limit. The glass-based compositions disclosed herein have a high fracture toughness and are capable of achieving high compressive stress levels while remaining non-frangible. These characteristics of the glass-based compositions enable the development of improved stress profiles designed to address particular failure modes. This capability allows the ion-exchanged glass-based articles produced from the glass-based compositions described herein to be customized with different stress profiles to address particular failure modes of concern.

The compositions described herein are selected to achieve high fracture toughness values while also maintaining a desired degree of manufacturability. The compositions include high amounts of Al₂O₃ and Li₂O to produce a desired fracture toughness while maintaining compatibility with desired manufacturing limits. The drop performance of ion-exchanged glass-based articles formed from the glass-based compositions described herein is improved by increasing the depth of compression (DOC), which may be achieved at least in part by selecting a high Li/Na molar ratio (e.g., from 1.2 to 2). The glass-based compositions described herein provide improved ion exchange performance, as evidenced by an increased central tension capability and increased ion exchange speed, while also avoiding volatility issues at free surfaces during manufacturing that may be introduced by B₂O₃ and P₂O₅ contents that are too high, when the concentration of Al₂O₃ is balanced against the concentration of SiO₂ and the concentration of alkali oxides in the glass-based composition, Al₂O₃ can reduce the liquidus temperature of the glass melt, thereby enhancing the liquidus viscosity and improving the compatibility of the glass-based composition with certain forming processes.

Contrary to the conventional expectation that lower liquidus viscosity has been associated with higher K_{IC} values and improved ion exchange capability, the Examples of the present disclosure demonstrate that a high fracture toughness (e.g., K_{IC} of 0.75 MPa√m or more) can be obtained simultaneously with a high liquidus viscosity (e.g., 100 kP or more, 150 kP or more, 175 kP or more, or from 200 kP to 300 kP). Without wishing to be bound by theory, it is believed that compositions of the present disclosure produced a different structure of the glass network that is associated with a non-spodumene crystal phase when the composition is crystalized. Without wishing to be bound by theory, it is believed that when a value of MgO+Li₂O—(CaO+SrO+Na₂O+K₂O) is slightly negative (e.g., from −4 to −0.5 or from −1.5 to −1), the glass-based composition may crystallize into a non-spodumene primary crystal phase that can be associated with increased liquidus viscosity (e.g., 100 kP or more, 150 kP or more, 175 kP or more, from 200 kP to 300 kP).

Providing RO can increase a volume resistivity of the resulting glass-based substrate and/or glass-based article, for example, because of the relatively high field strength of alkaline earth metal ions and/or decreasing a mobility of alkali metal ions. Providing glass-based substrates and/or glass-based articles with a high volume electrical resistivity (e.g., 2×10¹⁵ Ohm-centimeters or more, or from 1×10¹⁶ Ohm-centimeters to 1×10¹⁷ Ohm-centimeters) can decrease an incidence of electrostatic discharge that can discolor or otherwise damage glass-based substrates and/or glass-based articles, especially when the dimensions of the glass-based substrate and/or glass-based article is larger (e.g., 10 cm or more, or 20 cm or more).

Through different ion exchange processes, greater central tension (CT), depth of compression (DOC), and high compressive stress (CS) can be achieved. However, the addition of lithium in the aluminosilicate glass may reduce the melting point, softening point, or liquidus viscosity of the glass. By providing a glass-based substrate and/or a ceramic-based substrate comprising a first depth of compression and/or a second depth of compression in a range from about 20% to about 25% of the substrate thickness, good impact and/or puncture resistance can be enabled. The values of the ratio of the depth of layer (e.g., DOL_{SP}) to the depth of compression (e.g., DOC) (e.g., from 0.08 to 0.25 or from 0.18 to 0.25) in combination with the ratio of the compressive stress at the depth of the compressive stress spike to the corresponding maximum compressive stress (e.g., from 0.02 to 0.05) can be a characteristic of the compositions of the present disclosure, which may be distinctive from other compositions.

Aspect 1. A glass-based article comprising a composition, based on an oxide basis of the glass-based article, comprising:
from greater than or equal to 60 mol % to less than or equal to 69 mol % SiO₂;
from greater than or equal to 10 mol % to less than or equal to 18 mol % Al₂O₃;
from greater than or equal to 2.3 mol % to less than or equal to 6.9 mol % Li₂O;
from greater than or equal to 2.1 mol % to less than or equal to 6.7 mol % Na₂O; and
from greater than or equal to 1.1 mol % to less than or equal to 9 mol % RO, where RO is a sum of amounts of MgO, CaO, SrO, BaO, and ZnO,
wherein a liquidus viscosity of the composition is greater than or equal to 175 kiloPoise.

Aspect 2. A glass-based article comprising a composition, based on an oxide basis of the glass-based article, comprising:
from greater than or equal to 60 mol % to less than or equal to 69 mol % SiO₂;
from greater than or equal to 10 mol % to less than or equal to 18 mol % Al₂O₃;
from greater than or equal to 2.3 mol % to less than or equal to 6.9 mol % Li₂O;
from greater than or equal to 2.1 mol % to less than or equal to 6.7 mol % Na₂O;
from greater than or equal to 0.25 mol % to less than or equal to 1 mol % K₂O; and
from greater than or equal to 1.1 mol % to less than or equal to 9 mol % RO, where RO is a sum of amounts of MgO, CaO, SrO, BaO, and ZnO,
wherein a liquidus viscosity of the composition is greater than or equal to 150 kiloPoise.

Aspect 3. The glass-based article of aspect 2, wherein the liquidus viscosity is greater than or equal to 175 kiloPoise.

Aspect 4. The glass-based article of any one of aspects 1-3, wherein the liquidus viscosity is from greater than or equal to 200 kiloPoise to less than or equal to 300 kiloPoise.

Aspect 5. The glass-based article of any one of aspects 1-4, wherein the composition crystalizes to have a primary crystal phase comprising anorthoclase or a feldspar solid solution after being heated at 1050° C. for 24 hours.

Aspect 6. A glass-based article comprising a composition, based on an oxide basis of the glass-based article, comprising:
from greater than or equal to 60 mol % to less than or equal to 69 mol % SiO₂;
from greater than or equal to 10 mol % to less than or equal to 18 mol % Al₂O₃;
from greater than or equal to 2.3 mol % to less than or equal to 6.9 mol % Li₂O;
from greater than or equal to 2.1 mol % to less than or equal to 6.7 mol % Na₂O; and
from greater than or equal to 1.1 mol % to less than or equal to 9 mol % RO, where RO is a sum of amounts of MgO, CaO, SrO, BaO, and ZnO,
wherein the composition crystalizes to have a primary crystal phase comprising anorthoclase or a feldspar solid solution after being heated at 1050° C. for 24 hours.

Aspect 7. The glass-based article of any one of aspects 1-6, wherein a value of MgO+Li₂O−(CaO+SrO+Na₂O+K₂O) in mol % is from greater than or equal to −4 to less than or equal to −0.5.

Aspect 8. A glass-based article comprising a composition, based on an oxide basis of the glass-based article, comprising:
from greater than or equal to 60 mol % to less than or equal to 69 mol % SiO₂;
from greater than or equal to 10 mol % to less than or equal to 18 mol % Al₂O₃;
from greater than or equal to 2.3 mol % to less than or equal to 6.9 mol % Li₂O;
from greater than or equal to 2.1 mol % to less than or equal to 6.7 mol % Na₂O; and
from greater than or equal to 1.1 mol % to less than or equal to 9 mol % RO, where RO is a sum of amounts of MgO, CaO, SrO, BaO, and ZnO,
wherein a value of MgO+Li₂O−(CaO+SrO+Na₂O+K₂O) in mol % is from greater than or equal to −4 to less than or equal to −0.5.

Aspect 9. The glass-based article of any one of aspects 7-8, wherein the value of MgO+Li₂O−(CaO+SrO+Na₂O+K₂O) in mol % is greater than or equal to −1.5 to from less than or equal to −1.0.

Aspect 10. The glass-based article of any one of aspects 1-9, wherein the composition comprises:
from greater than or equal to 10 mol % to less than or equal to 16 mol % Al₂O₃;
greater than or equal to 0.5 mol % to P₂O₅; and
from greater than or equal to 0.5 mol % to less than or equal to 3.6 mol % B₂O₃.

Aspect 11. A glass-based article comprising a composition, based on an oxide basis of the glass-based article, comprising:
from greater than or equal to 60 mol % to less than or equal to 69 mol % SiO₂;
from greater than or equal to 10 mol % to less than or equal to 16 mol % Al₂O₃;
from greater than or equal to 2.3 mol % to less than or equal to 6.9 mol % Li₂O;
from greater than or equal to 2.1 mol % to less than or equal to 6.7 mol % Na₂O;
from greater than or equal to 0.5 mol % to less than or equal to 4.0 mol % P₂O₅;
from greater than or equal to 0.5 mol % to less than or equal to 3.6 mol % B₂O₃; and
from greater than or equal to 1.1 mol % to less than or equal to 9 mol % RO, where RO is a sum of amounts of MgO, CaO, SrO, BaO, and ZnO.

Aspect 12. The glass-based article of any one of aspects 1-11, wherein the composition comprises:
from greater than or equal to 2 mol % to less than or equal to 3.6 mol % B₂O₃.

Aspect 13. The glass-based article of any one of aspects 1-12, wherein a volume electrical resistivity is greater than or equal to 2×10¹⁵ Ohm-centimeters.

Aspect 14. A glass-based article comprising a composition, based on an oxide basis of the glass-based article, comprising:
from greater than or equal to 60 mol % to less than or equal to 69 mol % SiO₂;
from greater than or equal to 10 mol % to less than or equal to 18 mol % Al₂O₃;
from greater than or equal to 2.3 mol % to less than or equal to 6.9 mol % Li₂O;
from greater than or equal to 2.1 mol % to less than or equal to 6.7 mol % Na₂O;
from greater than or equal to 1.1 mol % to less than or equal to 9 mol % RO, where RO is a sum of amounts of MgO, CaO, SrO, BaO, and ZnO,
wherein a volume electrical resistivity of the glass-based article is greater than or equal to 2×10¹⁵ Ohm-centimeters.

Aspect 15. The glass-based article of any one of aspects 13-14, wherein the volume electrical resistivity is from greater than or equal to 1×10¹⁶ Ohm-centimeters to less than or equal to 1×10¹⁷ Ohm-centimeters.

Aspect 16. The glass-based article of any one of aspects 1-15, wherein the composition comprises:
from greater than or equal to 14 mol % to less than or equal to 16 mol % Al₂O₃.

Aspect 17. The glass-based article of any one of aspects 1-16, wherein the composition comprises:
from greater than or equal to 60 mol % to less than or equal to 66 mol % SiO₂;
from greater than or equal to 14 mol % to less than or equal to 16 mol % Al₂O₃;
from greater than or equal to 5 mol % to less than or equal to 6.9 mol % Li₂O;
from greater than or equal to 4 mol % to less than or equal to 6 mol % Na₂O;
from greater than or equal to 0.5 mol % to less than or equal to 3 mol % P₂O₅; and
from greater than 0 mol % to less than or equal to 1 mol % TiO₂.

Aspect 18. A glass-based article comprising a composition, based on an oxide basis of the glass-based article, comprising:
from greater than or equal to 60 mol % to less than or equal to 66 mol % SiO₂;
from greater than or equal to 14 mol % to less than or equal to 16 mol % Al₂O₃;
from greater than or equal to 5 mol % to less than or equal to 6.9 mol % Li₂O;
from greater than or equal to 4 mol % to less than or equal to 6 mol % Na₂O;
from greater than or equal to 0.5 mol % to less than or equal to 3 mol % P₂O₅;
from greater than or equal to 0.5 mol % to less than or equal to 5 mol % B₂O₃; and
from greater than 0 mol % to less than or equal to 1 mol % TiO₂.

Aspect 19. The glass-based article of any one of aspects 1-18, wherein the composition comprises:
from greater than or equal to 4.4 mol % to less than or equal to 6.8 mol % Li₂O; and
from greater than or equal to 3.5 mol % to less than or equal to 6.7 mol % Na₂O.

Aspect 20. The glass-based article of any one of aspects 1-19, wherein the composition comprises:
from greater than or equal to 6 mol % to less than or equal to 6.7 mol % Li₂O; and
from greater than or equal to 5 mol % to less than or equal to 5.8 mol % Na₂O.

Aspect 21. The glass-based article of any one of aspects 1-20, wherein a molar ratio of Li₂O/Na₂O is from greater than or equal to 1.2 to less than or equal to 2.1.

Aspect 22. The glass-based article of any one of aspects 1-21, wherein the glass-based article is substantially free of Ta₂O₅, HfO₂, La₂O₃, and Y₂O₃.

Aspect 23. The glass-based article of any one of aspects 1-22, wherein the composition is substantially free of ZnO.

Aspect 24. The glass-based article of any one of aspects 1-23, wherein the composition is substantially free of ZrO₂.

Aspect 25. The glass-based article of any one of aspects 1-24, further comprising: from greater than or equal to 0.1 mol % to less than or equal to 0.5 mol % TiO₂; and
from greater than or equal to 0.1 mol % to less than or equal to 1 mol % K₂O.

Aspect 26. The glass-based article of any one of aspects 1-25, wherein the composition comprises:
from greater than or equal to 0.25 mol % to less than or equal to 1 mol % K₂O.

Aspect 27. The glass-based article of any one of aspects 1-26, wherein the composition comprises:
from greater than or equal to 1.5 mol % to less than or equal to 3.3 mol % RO.

Aspect 28. The glass-based article of any one of aspects 1-27, wherein the composition comprises:
from greater than or equal to 0.1 mol % to less than or equal to 0.9 mol % MgO.

Aspect 29. The glass-based article of any one of aspects 1-28, wherein the composition comprises:
from greater than or equal to 1 mol % to less than or equal to 2 mol % CaO.

Aspect 30. The glass-based article of any one of aspects 1-29, wherein the composition comprises:
from greater than or equal to 0.6 mol % to less than or equal to 1.5 mol % SrO.

Aspect 31. The glass-based article of any one of aspects 1-30, wherein the composition comprises:
from greater than or equal to 0 mol % to less than or equal to 0.1 mol % SnO₂.

Aspect 32. The glass-based article of any one of aspects 1-31, wherein the composition comprises:
from greater than or equal to 64 mol % to less than or equal to 65 mol % SiO₂.

Aspect 33. The glass-based article of any one of aspects 1-32, wherein the composition comprises:
from greater than or equal to 15 mol % to less than or equal to 16 mol % Al₂O₃.

Aspect 34. The glass-based article of any one of aspects 1-33, wherein the composition comprises:
from greater than or equal to 0.5 mol % to less than or equal to 1.5 mol % P₂O₅.

Aspect 35. The glass-based article of any one of aspects 1-34, wherein the composition comprises:
from greater than or equal to 3 mol % to less than or equal to 3.5 mol % B₂O₃.

Aspect 36. The glass-based article of any one of aspects 1-35, wherein the glass-based article has a K_{IC} fracture toughness greater than or equal to 0.75 MPa·m^{0.5}.

Aspect 37. The glass-based article of any one of aspects 1-36, further comprising:
a compressive stress layer extending from a surface of the glass-based article to a depth of compression, the compressive stress layer comprising a maximum compressive stress; and
a central tension region comprising a maximum central tension,
wherein the composition corresponds to a material at a center of the glass-based article, and the glass-based article comprises a thickness t.

Aspect 38. The glass-based article of aspect 37, wherein the maximum compressive stress of the compressive stress layer is from greater than or equal to 500 MPa to less than or equal to 1000 MPa.

Aspect 39. The glass-based article of any one of aspects 37-38, wherein the maximum central tension of the central tension region is from greater than or equal to 50 MPa to less than or equal to 100 MPa.

Aspect 40. The glass-based article of any one of aspects 37-39, wherein the depth of compression is from greater than or equal to 0.15t to less than or equal to 0.25t, where t is the thickness of the glass-based article.

Aspect 41. The glass-based article of any one of aspects 37-40, further comprising a depth of layer of one or more alkali metal ions associated with the compressive stress layer, wherein a ratio of the depth of layer to the depth of compression is from greater than or equal to 0.02 to less than or equal to 0.05.

Aspect 42. The glass-based article of any one of aspects 37-41, wherein the compressive stress layer comprises a compressive stress spike extending from the surface of the glass-based article to a depth of the compressive stress spike, and a ratio a compressive stress at the depth of the compressive stress spike to the maximum compressive stress is from greater than or equal to 0.18 to less than or equal to 0.25.

Aspect 43. The glass-based article of any one of aspects 37-41, wherein the compressive stress layer comprises a compressive stress spike extending from the surface of the glass-based article to a depth of the compressive stress spike, and the depth of the compressive stress spike is from greater than or equal to 3 μm to less than or equal to 10 μm.

Aspect 44. The glass-based article of any one of aspects 37-43, wherein the thickness t is from greater than or equal to 0.02 mm to less than or equal to 2 mm.

Aspect 45. The glass-based article of aspect 44, wherein the thickness t is from greater than or equal to 0.5 mm to less than or equal to 2 mm.

Aspect 46. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover substrate disposed over the display,
wherein at least a portion of at least one of the housing and the cover substrate comprises the glass-based article of any one of aspects 1-45.

Aspect 47. A method of making the glass-based article of any one of aspects 1-45, the method comprising:
ion exchanging a glass-based substrate in a molten salt bath to form a glass-based article, wherein the glass-based article comprises a compressive stress layer extending from a surface of the glass-based article to a depth of compression, the glass-based article comprises a central tension region, and the glass-based substrate comprises the glass-based article of any one of claims 1-40.

Aspect 48. The method of aspect 47, wherein the molten salt bath comprises NaNO₃.

Aspect 49. The method of any one of aspects 47-48, wherein the molten salt bath comprises KNO₃.

Aspect 50. The method of any one of aspects 47-49, wherein the molten salt bath is at a temperature greater than or equal to 380° C. to less than or equal to 470° C.

Aspect 51. The method of any one of aspects 47-50, wherein the ion exchanging extends for a time period from greater than or equal to 10 minutes to less than or equal to 24 hours.

Aspect 52. The method of any one of aspects 47-51, further comprising ion exchanging the glass-based article in a second molten salt bath.

Aspect 53. The method of any one of aspects 47-52, wherein the second molten salt bath comprises KNO₃.

Aspect 54. The method of aspect 37, wherein the maximum compressive stress of the compressive stress layer is from greater than or equal to 500 MPa to less than or equal to 1500 MPa.

Aspect 55. The glass-based article of aspect 37 or aspect 54, wherein the maximum central tension of the central tension region is from greater than or equal to 50 MPa to less than or equal to 100 MPa.

Aspect 56. The glass-based article of any one of aspects 54-55, wherein the depth of compression is from greater than or equal to 0.15t to less than or equal to 0.25t, where t is the thickness of the glass-based article.

Aspect 57. The glass-based article of any one of aspects 37 or 54-56, further comprising a depth of layer of one or more alkali metal ions associated with the compressive stress layer, wherein a ratio of the depth of layer to the depth of compression is from greater than or equal to 0.02 to less than or equal to 0.08.

Aspect 58. The glass-based article of aspect 57, wherein the ratio of the depth of layer to the depth of compression is from greater than or equal to 0.04 to less than or equal to 0.06.

Aspect 59. The glass-based article of any one of aspects 54-58, wherein the compressive stress layer comprises a compressive stress spike extending from the surface of the glass-based article to a depth of the compressive stress spike, and a ratio a compressive stress at the depth of the compressive stress spike to the maximum compressive stress is from greater than or equal to 0.17 to less than or equal to 0.25.

Aspect 60. The glass-based article of any one of aspects 54-58, wherein the compressive stress layer comprises a compressive stress spike extending from the surface of the glass-based article to a depth of the compressive stress spike, and a ratio a compressive stress at the depth of the compressive stress spike to the maximum compressive stress is from greater than or equal to 0.08 to less than or equal to 0.20.

Aspect 61. The glass-based article of any one of aspects 54-60, wherein the compressive stress layer comprises a compressive stress spike extending from the surface of the glass-based article to a depth of the compressive stress spike, and the depth of the compressive stress spike is from greater than or equal to 3 μm to less than or equal to 10 μm.

Aspect 62. The glass-based article of any one of aspects 59-61, wherein a stress at the depth of the compressive stress spike is less than or equal to 210 MegaPascals.

Aspect 63. The glass-based article of any one of aspects 59-62, wherein a slope of the compressive stress spike is from greater than or equal to −220 MPa/μm to less than or equal to −60 MPa/μm.

Aspect 64. The glass-based article of any one of aspects 59-63, wherein a slope of a deep region extending from the depth of the compressive stress spike to the depth of compression is from greater than or equal to −1.8 MPa/μm to less than or equal to −1.1 MPa/μm.

Aspect 65. The glass-based article of any one of aspects 54-64, wherein a total stored strain energy in the glass-based article is less than or equal to 90 Joules per square meter.

Aspect 66. The glass-based article of any one of aspects 54-65, wherein the thickness t is from greater than or equal to 0.02 mm to less than or equal to 2 mm.

Aspect 67. The glass-based article of aspect 44 or aspect 66, wherein the thickness t is from greater than or equal to 0.4 mm to less than or equal to 2 mm.

Aspect 68. A method of making the glass-based article of any one of aspects 54-67, the method comprising:
ion exchanging a glass-based substrate in a molten salt bath to form a glass-based article, wherein the glass-based article comprises a compressive stress layer extending from a surface of the glass-based article to a depth of compression, the glass-based article comprises a central tension region, and the glass-based substrate comprises the glass-based article of any one of claims 54-65.

Aspect 69. The method of aspect 68, wherein the molten salt bath comprises NaNO₃.

Aspect 70. The method of any one of aspects 68-69, wherein the molten salt bath comprises KNO₃.

Aspect 71. The method of any one of aspects 47-49 or 68-70, wherein the molten salt bath is at a temperature greater than or equal to 350° C. to less than or equal to 500° C.

Aspect 72. The method of any one of aspects 68-70, wherein the molten salt bath is at a temperature greater than or equal to 380° C. to less than or equal to 470° C.

Aspect 73. The method of any one of aspects 47-50 or 68-72, wherein the ion exchanging extends for a time period from greater than or equal to 5 minutes to less than or equal to 24 hours.

Aspect 74. The method of any one of aspects 68-73, further comprising ion exchanging the glass-based article in a second molten salt bath.

Aspect 75. The method of aspect 74, wherein the second molten salt bath comprises KNO₃.

Aspect 76. The method of any one of aspects 74-75, wherein the second molten salt bath comprises K₂CO₃.

Aspect 77. The method of aspect 76, wherein an amount of K₂CO₃ in the second molten salt bath is from 1 wt % to 7 wt %.

Aspect 78. The glass-based article of any one of aspects 59-62, wherein a slope of the compressive stress spike is from greater than or equal to −300 MPa/μm to less than or equal to −60 MPa/μm.

Aspect 79. The glass-based article of any one of aspects 59-63, wherein a slope of a deep region extending from the depth of the compressive stress spike to the depth of compression is from greater than or equal to −2.0 MPa/μm to less than or equal to −1.1 MPa/μm.

Additional features and advantages will be set forth in the detailed description which follows, and in part will be readily apparent to those skilled in the art from that description or recognized by practicing the aspects and/or embodiments described herein, including the detailed description which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects and are incorporated into and constitute a part of this specification. The drawings illustrate the various aspects described herein, and together with the description serve to explain the principles and operations of the claimed subject matter.

### BRIEF DESCRIPTION OF THE DRAWINGS

FIG. 1 schematically depicts a cross section of a glass-based article having compressive stress regions according to aspects described and disclosed herein;

FIG. 2 is a plan view of an exemplary electronic device incorporating any of the glass-based articles disclosed herein;

FIG. 3 is a perspective view of the exemplary electronic device of FIG. 2;

FIG. 4 schematically illustrates a step of ion-exchanging the glass-based substrate to form a glass-based article;

FIG. 5 schematically illustrates an optional step of further ion-exchanging the glass-based substrate to form a glass-based article;

FIG. 6 is a plot of stress as a function of depth from a surface into the glass-based article DA of Composition 1;

FIG. 7 is a plot of stress as a function of depth from a surface into the glass-based article DB of Composition 2; and

FIG. 8 is a plot of stress as a function of depth from a surface into the glass-based articles DD, DG, DJ, and DM of Composition 9

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

Reference will now be made in detail to lithium aluminosilicate glasses according to various aspects. Lithium aluminosilicate glasses have good ion exchangeability, and chemical strengthening processes have been used to achieve high strength and high toughness properties in lithium aluminosilicate glasses. Lithium aluminosilicate glasses are highly ion exchangeable glasses with high glass quality. The substitution of Al₂O₃ into the silicate glass network increases the interdiffusivity of monovalent cations during ion exchange. By chemical strengthening in a molten salt bath (e.g., KNO₃ or NaNO₃), glasses with high strength, high toughness, and high indentation cracking resistance can be achieved. The stress profiles achieved through chemical strengthening may have a variety of shapes that increase the drop performance, strength, toughness, and other attributes of the glass-based articles.

Therefore, lithium aluminosilicate glasses with good physical properties, chemical durability, and ion exchangeability have drawn attention for use as a cover glass. In particular, lithium-containing aluminosilicate glasses, which have higher fracture toughness (e.g., at least 0.75 MPa√m) and reasonable raw material costs, are provided herein. The glasses described herein can achieve these fracture toughness values without the inclusion of additives, such as ZrO₂, Ta₂O₅, TiO₂, HfO₂, La₂O₃, and Y₂O₃, that increase the fracture toughness but are expensive and may have limited commercial availability. In this respect, the glasses disclosed herein provide comparable or improved performance with reduced manufacturing costs. Through different ion exchange processes, greater central tension (CT), depth of compression (DOC), and high compressive stress (CS) can be achieved. However, the addition of lithium in the aluminosilicate glass may reduce the melting point, softening point, or liquidus viscosity of the glass.

In aspects of glass-based compositions described herein, the concentration of constituent components (e.g., SiO₂, Al₂O₃, Li₂O, and the like) are given in mole percent (mol %) on an oxide basis, unless otherwise specified. Components of the alkali aluminosilicate glass-based composition according to embodiments are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits. Throughout the disclosure, the composition of glass-based articles and/or glass-based substrates refers to the composition of the formed article or substrate as determined in wt % by: X-ray fluorescence and comparison with standard samples for alumina, phosphorous, alkaline earth metals, transition metals (e.g., ZnO, TiO₂, Fe₂O₃, SnO₂), sodium oxide, and potassium oxide; an amount of B₂O₃ is measured using inductively coupled plasma (ICP) methods; an amount of lithium oxide (Li₂O) is measured using flame emission spectroscopy; and an amount of SiO₂ is taken as the balance of material (i.e., 100%—materials measured using X-ray fluorescence, ICP, and flame emission spectroscopy), and then the composition is converted from wt % to mol %, as reported herein. The composition refers to the composition of the formed article or substrate—not the raw materials added to form the glass-based article and/or glass-based substrate.

As used herein, a “glass-based substrate” refers to a glass-based piece that has not been ion exchanged. Similarly, a “glass-based article” refers to a glass-based piece that has been ion exchanged and is formed by subjecting a glass-based substrate to an ion exchange process. A “glass-based substrate” and a “glass-based article” are defined accordingly and include glass-based substrates and glass-based articles as well as substrates and articles that are made wholly or partly of a glass-based material, such as glass-based substrates that include a surface coating. While glass-based substrates and glass-based articles may generally be referred to herein for the sake of convenience, the descriptions of glass-based substrates and glass-based articles should be understood to apply equally to glass-based substrates and glass-based articles. Likewise, the claims are not necessarily limited to either an ion-exchanged glass-based article or a glass-based substrate that has not been ion exchanged unless otherwise indicated.

As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates.

While scratch performance is desirable, drop performance is the leading attribute for glass-based articles incorporated into mobile electronic devices. Fracture toughness and stress at depth are critical for improved drop performance on rough surfaces. For this reason, maximizing the amount of stress that can be provided in a glass-based article before reaching a frangibility limit increases the stress at depth and the rough surface drop performance. The fracture toughness is known to control the frangibility limit and increasing the fracture toughness increases the frangibility limit. The glass-based compositions disclosed herein have a high fracture toughness and are capable of achieving high compressive stress levels while remaining non-frangible. These characteristics of the glass-based compositions enable the development of improved stress profiles designed to address particular failure modes. This capability allows the ion-exchanged glass-based articles produced from the glass-based compositions described herein to be customized with different stress profiles to address particular failure modes of concern.

The compositions described herein are selected to achieve high fracture toughness values while also maintaining a desired degree of manufacturability. The compositions include high amounts of Al₂O₃ and Li₂O to produce a desired fracture toughness while maintaining compatibility with desired manufacturing limits. The drop performance of ion-exchanged glass-based articles formed from the glass-based compositions described herein is improved by increasing the depth of compression (DOC), which may be achieved at least in part by selecting a high Li/Na molar ratio. The glass-based compositions described herein provide improved ion exchange performance, as evidenced by an increased central tension capability and increased ion exchange speed, while also avoiding volatility issues at free surfaces during manufacturing that may be introduced by B₂O₃ and P₂O₅ contents that are too high.

In the glass-based compositions described herein, SiO₂ is the largest constituent and, as such, SiO₂ is the primary constituent of the glass network formed from the glass-based composition. Pure SiO₂ has a relatively low CTE. However, pure SiO₂ has a high melting point. Accordingly, if the concentration of SiO₂ in the glass-based composition is too high, the formability of the glass-based composition may be diminished as higher concentrations of SiO₂ increase the difficulty of melting the glass, which, in turn, adversely impacts the formability of the composition. If the concentration of SiO₂ in the glass-based composition is too low the chemical durability of the glass-based material may be diminished, and the glass-based material may be susceptible to surface damage during post-forming treatments. In aspects, the composition comprises SiO₂ in an amount of 60 mol % or more, 61 mol % or more, 62 mol % or more, 63 mol % or more, 63.5 mol % or more, 64 mol % or more, 69 mol % or less, 68 mol % or less, 67 mol % or less, 66 mol % or less, 65.5 mol % or less, 65 mol % or less, or about 64.5 mol % or less. In aspects, the composition can comprise SiO₂ in a range from greater than or equal to 60 mol % to less than or equal to 69 mol %, from greater than or equal to 60 mol % to less than or equal to 68 mol %, from greater than or equal to 60 mol % to less than or equal to 67 mol %, from greater than or equal to 60 mol % to less than or equal to 66 mol %, from greater than or equal to 61 mol % to less than or equal to 65.5 mol %, from greater than or equal to 62 mol % to less than or equal to 65.5 mol %, from greater than or equal to 63 mol % to less than or equal to 65 mol %, from greater than or equal to 63.5 mol % to than or equal to 65 mol %, from greater than or equal to 64 mol % to less than or equal to 65 mol %, or any range or subrange therebetween. In preferred aspects, the composition comprises SiO₂ in an amount from greater than or equal to 60 mol % to less than or equal to 69 mol %, from greater than or equal to 60 mol % to less than or equal to 66 mol %, or from greater than or equal to 64 mol % to less than or equal to 65 mol %.

The glass-based compositions include Al₂O₃. Al₂O₃ may serve as a glass network former, similar to SiO₂. Al₂O₃ may increase the viscosity of the glass-based composition due to its tetrahedral coordination in a glass melt formed from a glass-based composition, decreasing the formability of the glass-based composition when the amount of Al₂O₃ is too high. However, when the concentration of Al₂O₃ is balanced against the concentration of SiO₂ and the concentration of alkali oxides in the glass-based composition, Al₂O₃ can reduce the liquidus temperature of the glass melt, thereby enhancing the liquidus viscosity and improving the compatibility of the glass-based composition with certain forming processes. The inclusion of Al₂O₃ in the glass-based compositions can enable the high fracture toughness values described herein. In aspects, the composition comprises Al₂O₃ in a concentration of 10 mol % or more, 11 mol % or more, 12 mol % or more, 13 mol % or more, 14 mol % or more, 14.5 mol % or more, 15 mol % or more, 18 mol % or less, 17 mol % or less, 16 mol % or less, or 15.5 mol % or less. In aspects, the composition can comprise an amount of Al₂O₃ in a range from greater than or equal to 10 mol % to less than or equal to 18 mol %, from greater than or equal to 10 mol % to less than or equal to 17 mol %, from greater than or equal to 10 mol % to less than or equal to 16 mol %, from greater than or equal to 11 mol % to less than or equal to 16 mol %, from greater than or equal to 12 mol % to less than or equal to 16 mol %, from greater than or equal to 13 mol % to less than or equal to 16 mol %, from greater than or equal to 14 mol % to less than or equal to 16 mol %, from greater than or equal to 14.5 mol % to less than or equal to 16 mol %, from greater than or equal to 15 mol % to less than or equal to 16 mol %, or any range or subrange therebetween. In preferred aspects, the composition comprises Al₂O₃ in an amount from greater than or equal to 10 mol % to less than or equal to 18 mol %, from greater than or equal to 14 mol % to less than or equal to 16 mol %, or from greater from greater than or equal to 14 mol % to less than or equal to 15 mol %.

The glass-based compositions include Li₂O. The inclusion of Li₂O in the glass-based composition allows for better control of an ion exchange process and further reduces the softening point of the composition, thereby increasing the manufacturability of the composition. The presence of Li₂O in the glass-based compositions also allows the formation of a stress profile with a parabolic shape. The Li₂O in the glass-based compositions can enable the high fracture toughness values described herein. In aspects, the composition comprises Li₂O in an amount from 2.3 mol % or more, 3 mol % or more, 3.5 mol % or more, 4 mol % or more, 4.4 mol % or more, 5 mol % or more, 5.3 mol % or more, 5.5 mol % or more, 6 mol % or more (e.g., 6.0 mol % or more), 6.9 mol % or less, 6.8 mol % or less, 6.7 mol % or less, 6.6 mol % or less, 6.5 mol % or less, 6.3 mol % or less, or 6 mol % or less (e.g., 6.0 mol % or less). In aspects, the composition comprises an amount of Li₂O in a range from greater from greater than or equal to 2.3 mol % to less than or equal to 6.9 mol %, from greater than or equal to 3 mol % to less than or equal to 6.9 mol %, from greater than or equal to 4 mol % to less than or equal to 6.9 mol %, from greater than or equal to 4.5 mol % to less than or equal to 6.9 mol %, from greater than or equal to 4.4 mol % to less than or equal to 6.8 mol %, from greater than or equal to 5 mol % to less than or equal to 6.7 mol %, from greater than or equal to 5.3 mol % to less than or equal to 6.7 mol %, from greater than or equal to 5.5 mol % to less than or equal to 6.7 mol %, from greater than or equal to 6 mol % to less than or equal to 6.7 mol % (e.g., from greater than or equal to 6.0 mol % to less than or equal to 6.7 mol %), or any range or subrange therebetween. In aspects, the composition can comprise greater than or equal to 5 mol % Li₂O and less than or equal to 6.9 mol %, for example, in a range from greater than or equal to 5.3 mol % to less than or equal to 6.8 mol %, from greater than or equal to 5.5 mol % to less than or equal to 6.8 mol %, from greater than or equal to 5.5 mol % to less than or equal to 6.6 mol %, from greater than or equal to 6 mol % to less than or equal to 6.5 mol %, or any range or subrange therebetween. In preferred aspects, the composition comprises Li₂O in an amount from greater than or equal to 2.3 mol % to less than or equal to 6.9 mol %, from greater than or equal to 5 mol % to less than or equal to 6.8 mol %, or from than or equal to 6 mol % to less than or equal to 6.7 mol %.

The glass-based compositions described herein include Na₂O. Na₂O may aid in the ion-exchangeability of the glass-based composition, and improve the formability, and thereby manufacturability, of the glass-based composition. However, if too much Na₂O is added to the glass-based composition, the CTE may be too low, and the melting point may be too high.

Additionally, if too much Na₂O is included in the composition relative to the amount of Li₂O the ability of the glass-based substrate to achieve a deep depth of compression when ion exchanged may be reduced. In aspects, the composition comprises Na₂O in an amount of 2.1 mol % or more, 2.5 mol % or more, 3 mol % or more, 3.5 mol % or more, 4 mol % or more, 4.5 mol % or more, 5 mol % or more (e.g., 5.0 mol % or more), 5.5 mol % or more, 6.7 mol % or less, 6.5 mol % or less, 6.3 mol % or less, 6 mol % or less (e.g., 6.0 mol % or less), 5.8 mol % or less, or 5.5 mol % or less. In aspects, the composition comprises an amount of Na₂O in a range from greater than or equal to 2.1 mol % to less than or equal to 6.7 mol %, from greater than or equal to 3 mol % to less than or equal to 6.7 mol %, from greater than or equal to 3.5 mol % to less than or equal to 6.7 mol %, from greater than or equal to 4 mol % to less than or equal to 6.5 mol %, from greater than or equal to 4 mol % to less than or equal to 6.3 mol %, from greater than or equal to 4 mol % to less than or equal to 6 mol %, from greater than or equal to 4.5 mol % to less than or equal to 6 mol % (e.g., from greater than or equal to 4.5 mol % to less than or equal to 6.0 mol %), from greater than or equal to 5 mol % to less than or equal to 5.8 mol % (e.g., from greater than or equal to 5.0 mol % to less than or equal to 5.8 mol %), or any range or subrange therebetween. In preferred aspects, the composition comprises Na₂O in an amount from greater than or equal to 2.1 mol % to less than or equal to 6.7 mol % Na₂O, greater than or equal to 3.5 mol % to less than or equal to 6 mol %, from greater than or equal to 4 mol % to less than or equal to 5.8 mol %.

The glass-based compositions described herein may be described in terms of a lithium to sodium molar ratio (Li₂O/Na₂O). A high Li₂O/Na₂O molar ratio allows a deep depth of compression (DOC) to be achieved when the glass-based compositions are ion exchanged. The increased DOC capability attributable to the high Li₂O/Na₂O molar ratios allows the ion-exchanged articles formed from the glass-based compositions to exhibit improved drop performance, especially on rough surfaces. In aspects, the composition can be characterized by a molar ratio of Li₂O/Na₂O of 1.15 or more, 1.2 or more, 1.25 or more, 1.3 or more, 1.5 or more, 1.6 or more, 2.1 or less, 2 or less, 1.9 or less, 1.8 or less, 1.7 or less, 1.6 or less, 1.5 or less, 1.4 or less, 1.35 or less, or 1.3 or less (e.g., 1.30 or less). In aspects, the composition can be characterized by a molar ratio of Li₂O/Na₂O in a range from greater than or equal to 1.15 to less than or equal to 2.1, from greater than or equal to 1.2 to less than or equal to 2.1, from greater than or equal to 1.2 to less than or equal to 2, from greater than or equal to 1.2 to less than or equal to 1.9, from greater than or equal to 1.25 to less than or equal to 1.8, from greater than or equal to 1.25 to less than or equal to 1.7, from greater than or equal to 1.25 to less than or equal to 1.6, from greater than or equal to 1.3 to less than or equal to 1.5, or any range or subrange therebetween. In aspects, the composition can be characterized by a molar ratio of Li₂O/Na₂O in a range from greater than or equal to 1.15 to less than or equal to 1.8, from greater than or equal to 1.2 to less than or equal to 1.7, from greater than or equal to 1.25 to less than or equal to 1.5, from greater than or equal to 1.25 to less than or equal to 1.4, from greater than or equal to 1.25 to less than or equal to 1.35, or from greater than or equal to 1.25 to less than or equal to 1.3 (e.g., from greater than or equal to 1.25 to less than or equal to 1.30), or any range or subrange therebetween. In preferred aspects, the composition comprises a molar ratio of Li₂O/Na₂O in a range from greater than or equal to 1.2 to less than or equal to 2.1, from great than or equal to 1.25 to less than or equal to 1.6, or from greater than or equal to 1.25 to less than or equal to 1.30.

The glass-based compositions may include K₂O. The inclusion of K₂O in the glass-based composition increases the potassium diffusivity in the glass-based material, enabling a deeper depth of a compressive stress spike (DOL_{SP}) to be achieved in a shorter amount of ion exchange time. If too much K₂O is included in the composition the amount of compressive stress imparted during an ion-exchange process may be reduced. In aspects, the composition can comprise K₂O in an amount of 0 mol % or more, 0.1 mol % or more, 0.25 mol % or more, 0.3 mol % or more, 0.35 mol % or more, 1 mol % or less, 0.75 mol % or less, 0.6 mol % or less, 0.5 mol % or less (e.g., 0.50 mol % or less), or 0.4 mol % or less. In aspects, the composition can comprise an amount of K₂O in a range from greater than or equal to 0 mol % to less than or equal to 1 mol %, from greater than or equal to 0.1 mol % to less than or equal to 1 mol %, greater than or equal to 0.25 mol % to less than or equal to 1 mol %, from greater than or equal to 0.25 mol % to less than or equal to 0.75 mol %, from greater than or equal to 0.25 mol % to less than or equal to 0.6 mol %, from greater than or equal to 0.3 mol % to less than or equal to 0.5 mol %, from greater than or equal to 0.3 mol % to less than or equal to 0.4 mol %, or any range or subrange therebetween. In preferred aspects, the composition can comprise an amount of K₂O in a range from greater than or equal to 0 mol % to less than or equal to 1 mol %, from greater than or equal to 0.1 mol % to less than or equal to 1 mol %, or from greater than or equal to 0.25 mol % to less than or equal to 0.5 mol %.

Throughout the disclosure, “RO” refers to a total amount of alkaline earth oxides and divalent transition metal oxides. “RO” can refer to a total amount of MgO, CaO, SrO, BaO, and ZnO. In aspects, divalent cation oxides (e.g., alkaline earth oxides) can improve the melting behavior of glass compositions. In aspects, divalent cation oxides can improve stress relaxation. In aspects, alkaline earth oxides can charge balance tetrahedral alumina. Providing RO can increase a volume resistivity of the resulting glass-based substrate and/or glass-based article, for example, because of the relatively high field strength of alkaline earth metal ions and/or decreasing a mobility of alkali metal ions. In aspects, the composition can comprise RO in an amount of 1.1 mol % or more, 1.3 mol % or more, 1.5 mol % or more, 1.8 mol % or more, 2 mol % or more, 2.2 mol % or more, 2.5 mol % or more, 2.8 mol % or more, 3 mol % or more (e.g., 3.00 mol % or more), 9 mol % or less, 8 mol % or less, 7 mol % or less, 6 mol % or less, 5 mol % or less, 4 mol % or less, 3.5 mol % or less (e.g., 3.50 mol % or less), 3.4 mol % or less (e.g., 3.40 mol % or less), 3.3 mol % or less (e.g., 3.30 mol % or less), 3.25 mol % or less, 3.2 mol % or less (e.g., 3.20 mol % or less), 3.15 mol % or less, or 3.1 mol % or less (e.g., 3.10 mol % or less). In aspects, the composition can comprise an amount of RO in a range from greater than or equal to 1.1 mol % to less than or equal to 9 mol %, from greater than or equal to 1.1 mol % to less than or equal to 7 mol %, from greater than or equal to 1.1 mol % to less than or equal to 5 mol %, from greater than or equal to 1.3 mol % to less than or equal to 4 mol %, from greater than or equal to 1.3 mol % to less than or equal to 3.5 mol %, from greater than or equal to 1.5 mol % to less than or equal to 3.3 mol % (e.g., from greater than or equal to 1.5 mol % to less than or equal to 3.30 mol %), from greater than or equal to 1.8 mol % to less than or equal to 3.3 mol % (e.g., from greater than or equal to 1.8 mol % to less than or equal to 3.30 mol %), from greater than or equal to 2 mol % to less than or equal to 3.25 mol %, from greater than or equal to 2.5 mol % to less than or equal to 3.25 mol %, from greater than or equal to 2.8 mol % to less than or equal to 3.2 mol % (e.g., from greater than or equal to 2.8 mol % to less than or equal to 3.20 mol %), from greater than or equal to 3 mol % to less than or equal to 3.2 mol % (e.g., from greater than or equal to 3.00 mol % to less than or equal to 3.20 mol %), from greater than or equal to 3 mol % to less than or equal to 3.15 mol %, or any range or subrange therebetween. In preferred aspects, the composition comprises RO in an amount from greater than or equal to 1.1 mol % to less than or equal to 9 mol % or from 1.5 mol % to 3.3 mol %.

The glass-based compositions described herein may optionally include MgO. MgO may lower the viscosity of a glass, which enhances the formability and manufacturability of the composition. The inclusion of MgO in a glass-based composition may also improve the strain point and the Young's modulus of the glass-based composition. However, if too much MgO is added to the glass-based composition, the liquidus viscosity may be too low for compatibility with desirable forming techniques. The addition of too much MgO may also increase the density and the CTE of the glass-based composition to undesirable levels. The inclusion of MgO in the glass-based composition also helps to achieve the high fracture toughness values described herein. In aspects, the composition can comprise MgO in an amount of 0 mol % or more, 0.1 mol % or more, 0.3 mol % or more, 0.4 mol % or more (e.g., 0.40 mol % or more), 0.5 mol % or more (e.g., 0.50 mol % or more), 0.9 mol % or less, 0.8 mol % or less, 0.7 mol % or less, or 0.6 mol % or less (e.g., 0.60 mol % or less). In aspects, the composition can comprise an amount of MgO in a range from greater than or equal to 0 mol % to less than or equal to 0.9 mol %, from greater than or equal to 0.1 mol % to less than or equal to 0.9 mol %, from greater than or equal to 0.3 mol % to less than or equal to 0.8 mol %, from greater than or equal to 0.4 mol % to less than or equal to 0.7 mol % (e.g., from greater than or equal to 0.40 mol % to less than or equal to 0.7 mol %), from greater than or equal to 0.5 mol % to less than or equal to 0.6 mol % (e.g., from greater than or equal to 0.50 mol % to less than or equal to 0.60 mol %), or any range or subrange therebetween. In aspects, the glass-based composition can be substantially free or free of MgO. As used herein, the term “substantially free” means that the component is not purposefully added as a component of the batch material even though the component may be present in the final glass-based composition in very small amounts as a contaminant, such as less than 0.1 mol %. In preferred aspects, the composition comprises MgO in an amount from greater than or equal to 0 mol % to less than or equal to 1 mol %, from greater than or equal to 0.1 mol % to less than or equal to 0.9 mol %, or from greater than or equal to 0.40 mol % to less than or equal to 0.60 mol %.

The glass-based compositions described herein may include CaO. CaO may lower the viscosity of a glass, which may enhance the formability, the strain point, and the Young's modulus. However, if too much CaO is added to the glass-based composition, the density and the CTE of the glass-based composition may increase to undesirable levels and the ion exchangeability of the glass-based substrate may be undesirably impeded. The inclusion of CaO in the glass-based composition also helps to achieve the high fracture toughness values described herein. In aspects, the composition can comprise CaO in an amount of 1 mol % or more, 1.2 mol % or more, 1.3 mol % or more, 1.4 mol % or more (e.g., 1.40 mol % or more), 2 mol % or less, 1.8 mol % or less, 1.7 mol % or less, 1.6 mol % or less (e.g., 1.60 mol % or less), or 1.5 mol % or less (e.g., 1.50 mol % or less). In aspects, the composition can comprise an amount of CaO in a range from greater than or equal to 1 mol % to less than or equal to 2 mol %, from greater than or equal to 1.2 mol % to less than or equal to 1.8 mol %, from greater than or equal to 1.3 mol % to less than or equal to 1.7 mol %, from greater than or equal to 1.4 mol % to less than or equal to 1.6 mol % (e.g., from greater than or equal to 1.40 mol % to less than or equal to 1.60 mol %), from greater than or equal to 1.4 mol % to less than or equal to 1.5 mol % (e.g., from greater than or equal to 1.40 mol % to less than or equal to 1.50 mol %), or any range or subrange therebetween. In preferred aspects, the composition comprises CaO in an amount from greater than or equal to 1 mol % to less than or equal to 2 mol % or from greater than or equal to 1.40 mol % to less than or equal to 1.60 mol %.

The glass-based compositions described herein may include SrO. SrO may lower the viscosity of a glass, which may enhance the formability, the strain point, and the Young's modulus. However, if too much SrO is added to the glass-based composition, the density and the CTE of the glass-based composition may increase to undesirable levels and the ion exchangeability of the glass-based substrate may be undesirably impeded. The inclusion of SrO in the glass-based composition also helps to achieve the high fracture toughness values described herein. In aspects, the composition comprises SrO in an amount of 0.6 mol % or more, 0.8 mol % or more, 0.9 mol % or more (e.g., 0.90 mol % or more), 1 mol % or more, 1.5 mol % or less, 1.5 mol % or less, 1.4 mol % or less, 1.3 mol % or less, 1.2 mol % or less (e.g., 1.20 mol % or less), or 1.1 mol % or less. In aspects, the composition can comprise an amount of SrO in a range from greater than or equal to 0.6 mol % to less than or equal to 1.5 mol %, from greater than or equal to 0.8 mol % to less than or equal to 1.4 mol %, from greater than or equal to 0.8 mol % to less than or equal to 1.3 mol %, from greater than or equal to 0.9 mol % to less than or equal to 1.2 mol % (e.g., from greater than or equal to 0.90 mol % to less than or equal to 1.20 mol %), from greater than or equal to 1 mol % to less than or equal to 1.1 mol %, or any range or subrange therebetween. In preferred aspects, the composition comprises SrO in an amount from greater than or equal to 0.6 mol % to less than or equal to 1.5 mol % or from greater than or equal to 0.90 mol % to less than or equal to 1.20 mol %.

The glass-based compositions described herein may optionally include ZnO. ZnO may lower the viscosity of a glass, which may enhance the formability, the strain point, and the Young's modulus. However, if too much ZnO is added to the glass-based composition, the density and the CTE of the glass-based composition may increase to undesirable levels. The inclusion of ZnO in the glass-based composition also helps to achieve the high fracture toughness values described herein and provides protection against UV induced discoloration. In aspects, the glass-based composition comprises ZnO in an amount from greater than or equal to 0 mol % to less than or equal to 1 mol %, such as from greater than 0 mol % to less than or equal to 1.0 mol %, from greater than or equal to 0.1 mol % to less than or equal to 0.9 mol %, from greater than or equal to 0.2 mol % to less than or equal to 0.8 mol %, from greater than or equal to 0.3 mol % to less than or equal to 0.7 mol %, from greater than or equal to 0.4 mol % to less than or equal to 0.6 mol %, from greater than or equal to 0.1 mol % to less than or equal to 0.5 mol %, from greater than or equal to 0 mol % to less than or equal to 0.3 mol %, and all ranges and sub-ranges between the foregoing values. Alternatively, in aspects, the glass-based composition is substantially free or free of ZnO.

The glass-based compositions described herein can include P₂O₅. The inclusion of P₂O₅ increases the diffusivity of ions in the glass-based, increasing the speed of the ion exchange process. If too much P₂O₅ is included in the composition the amount of compressive stress imparted in an ion exchange process may be reduced and volatility at free surfaces during manufacturing may increase to undesirable levels. In aspects, the composition comprises P₂O₅ in an amount of 0.5 mol % or more, 0.7 mol % or more, 0.9 mol % or more, 1 mol % or more, 1.1 mol % or more, 4 mol % or less, 3.5 mol % or less, 3 mol % or less, 2.5 mol % or less, 2 mol % or less, or 1.5 mol % or less. In aspects, composition comprises an amount of P₂O₅ in a range from greater than or equal to 0.5 mol % to less than or equal to 4 mol %, from greater than or equal to 0.5 mol % to less than or equal to 3 mol %, from greater than or equal to 0.5 mol % to less than or equal to 2.5 mol %, from greater than or equal to 0.5 mol % to less than or equal to 2 mol %, from greater than or equal to 0.5 mol % to less than or equal to 1.5 mol %, from greater than or equal to 0.7 mol % to less than or equal to 1.5 mol %, from greater than or equal to 0.9 mol % to less than or equal to 1.5 mol %, from greater than or equal to 1 mol % to less than or equal to 1.5 mol %, from greater than or equal to 1.1 mol % to less than or equal to 1.5 mol %, or any range or subrange therebetween. Alternatively, in aspects, the glass-based composition is substantially free or free of P₂O₅. In preferred aspects, the composition comprises P₂O₅ in an amount from greater than or equal to 0.5 mol % to less than or equal to 4 mol %, from greater than or equal to 0.5 mol % to less than or equal to 3 mol %, or from greater than or equal to 0.5 mol % to less than or equal to 1.5 mol %.

The glass-based compositions described herein can include B₂O₃. The inclusion of B₂O₃ increases the fracture toughness of the glass-based material. In particular, the glass-based compositions include boron in the trigonal configuration which increases the Knoop scratch threshold and fracture toughness of the glass-based article. If too much B₂O₃ is included in the composition the amount of compressive stress imparted in an ion exchange process may be reduced and volatility at free surfaces during manufacturing may increase to undesirable levels.

In aspects, the composition can comprise B₂O₃ in an amount of 0.5 mol % or more, 1 mol % or more, 1.5 mol % or more, 2 mol % or more, 2.5 mol % or more, 3 mol % or more (e.g., 3.00 mol % or more), 5 mol % or less, 4.5 mol % or less, 4 mol % or less, 3.8 mol % or less, 3.6 mol % or less, or 3.5 mol % or less (e.g., 3.50 mol % or less). In aspects, the composition can comprise an amount of B₂O₃ in a range from greater than or equal to 0.5 mol % to less than or equal to 5 mol %, from greater than or equal to 0.5 mol % to less than or equal to 4 mol %, from greater than or equal to 0.5 mol % to less than or equal to 3.6 mol %, from greater than or equal to 1 mol % to less than or equal to 3.6 mol %, from greater than or equal to 2 mol % to less than or equal to 3.6 mol %, from greater than or equal to 2.5 mol % to less than or equal to 3.5 mol %, from greater than or equal to 3 mol % to less than or equal to 3.5 mol % (e.g., from greater than or equal to 3.00 mol % to less than or equal to 3.50 mol %), or any range or subrange therebetween. Alternatively, in aspects, the glass-based composition is substantially free or free of B₂O₃. In preferred aspects, the composition comprises B₂O₃ in an amount from greater than or equal to 0.5 mol % to less than or equal to 3.6 mol %, from greater than or equal to 2 mol % to less than or equal to 3.6 mol %, or from greater than or equal to 3 mol % to less than or equal to 3.5 mol %.

The glass-based compositions described herein can optionally include TiO₂. The inclusion of too much TiO₂ in the glass-based composition may result in the composition being susceptible to devitrification and/or exhibiting an undesirable coloration as well as undesirably changing the liquidus. The inclusion of TiO₂ in the glass-based composition prevents the undesirable discoloration of the glass-based material if exposed to intense ultraviolet light, such as during post-processing treatments. In aspects, the composition can comprise TiO₂ in an amount of 0 mol % or more, 0.1 mol % or more, 0.15 mol % or more, 1 mol % or less, 0.5 mol % or less, or 0.3 mol % or less. In aspects, the composition can comprise an amount of TiO₂ in a range from greater than or equal to 0 mol % to less than or equal to 1 mol %, from greater than or equal to 0.1 mol % to less than or equal to 0.5 mol %, from greater than or equal to 0.15 mol % to less than or equal to 0.3 mol %, or any range or subrange therebetween. Alternatively, in aspects, the glass-based composition is substantially free or free of TiO₂. In preferred aspects, the composition comprises TiO₂ in an amount from greater than or equal to 0 mol % to less than or equal to 1 mol % or from greater than or equal to 0.1 mol % to less than or equal to 0.5 mol %.

The glass-based compositions may optionally include one or more fining agents. In aspects, the fining agent may include, for example, SnO₂. In aspects, SnO₂ may be present in the glass-based composition in an amount less than or equal to 0.2 mol %, such as from greater than or equal to 0 mol % to less than or equal to 0.2 mol %, greater than or equal to 0 mol % to less than or equal to 0.1 mol %, greater than or equal to 0 mol % to less than or equal to 0.05 mol %, greater than or equal to 0.1 mol % to less than or equal to 0.2 mol %, and all ranges and sub-ranges between the foregoing values. In some aspects, the glass-based composition may be substantially free or free of SnO₂. In aspects, the glass-based composition may be substantially free or free of one or both of arsenic and antimony. In preferred aspects, the composition comprises SnO₂ in an amount from greater than or equal to 0 mol % to less than or equal to 0.2 mol % or from greater than or equal to 0 mol % to less than or equal to 0.1 mol %.

In aspects, the glass-based composition can optionally comprise Fe₂O₃ in an amount of 0 mol % or more, 0.001 mol % or more, 0.005 mol % or more, 0.01 mol % or more, 0.015 mol % or more, 0.02 mol % or more, 0.1 mol % or less, 0.05 mol % or less, 0.03 mol % or less, or 0.02 mol % or less. In aspects, the glass-based composition can optionally comprise Fe₂O₃ in an amount in a range from greater than or equal to 0 mol % to less than or equal to 0.1 mol %, from greater than or equal to 0.001 mol % to less than or equal to 0.05 mol %, from greater than or equal to 0.005 mol % to less than or equal to 0.03 mol %, from greater than or equal to 0.01 mol % to less than or equal to 0.03 mol %, or any range or subrange therebetween. Alternatively, in aspects, the glass-based composition may be substantially free or free of Fe₂O₃. Iron is often present in raw materials utilized to form glass-based compositions, and as a result may be detectable in the glass-based compositions described herein even when not actively added to the glass-based batch. In preferred aspects, the composition comprises Fe₂O₃ in an amount from greater than or equal to 0 mol % to less than or equal to 0.1 mol %, from 0.0001 mol % to 0.05 mol %, or from 0.01 mol % to 0.03 mol %.

The glass-based compositions described herein may be formed primarily from (i.e., containing 0.5 mol % or more of each) SiO₂, Al₂O₃, Li₂O, Na₂O, K₂O, MgO, CaO, SrO, P₂O₅, and B₂O₃. In aspects, the glass-based compositions are substantially free or free of components other than SiO₂, Al₂O₃, Li₂O, Na₂O, K₂O, MgO, CaO, SrO, P₂O₅, B₂O₃, Fe₂O₃, TiO₂, and/or a fining agent (e.g., SnO₂). In aspects, the glass-based compositions are substantially free or free of components other than SiO₂, Al₂O₃, Li₂O, Na₂O, K₂O, MgO, CaO, SrO, P₂O₅, B₂O₃, TiO₂, and/or a fining agent.

In aspects, the glass-based composition may be substantially free or free of ZrO₂. The inclusion of ZrO₂ in the glass-based composition may result in the formation of undesirable zirconia inclusions in the glass-based material, due at least in part to the low solubility of ZrO₂ in the glass-based material. While the inclusion of ZrO₂ in the glass-based composition may increase the fracture toughness, there are cost and supply constraints as well as the previously described devitrification issues that may make using these components undesirable for commercial purposes. Stated differently, the ability of the glass-based compositions described herein to achieve high fracture toughness values within the inclusion of ZrO₂ provides a cost and manufacturability advantage.

In aspects, the glass-based composition may be substantially free or free of at least one of Ta₂O₅, HfO₂, La₂O₃, and Y₂O₃. In aspects, the glass-based composition may be substantially free or free of Ta₂O₅, HfO₂, La₂O₃, and Y₂O₃. While these components may increase the fracture toughness of the glass-based when included, there are cost and supply constraints that make using these components undesirable for commercial purposes. Stated differently, the ability of the glass-based compositions described herein to achieve high fracture toughness values within the inclusion of Ta₂O₅, HfO₂, La₂O₃, and Y₂O₃ provides a cost and manufacturability advantage.

The glass-based compositions described herein have liquidus viscosities that are compatible with manufacturing processes that are especially suitable for forming thin glass sheets. For example, the glass compositions are compatible with down draw processes such as fusion-draw processes or slot draw processes. Embodiments of the glass-based substrates may be described as fusion-formable (i.e., formable using a fusion-draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass-based article. The fusion of the glass films produces a fusion line within the glass-based substrate, and this fusion line allows glass-based substrates that were fusion formed to be identified without additional knowledge of the manufacturing history. The fusion-draw method offers the advantage that, because the two glass films flowing over the channel fuse together, neither of the outside surfaces of the resulting glass-based article comes in contact with any part of the apparatus. Thus, the surface properties of the fusion-drawn glass-based article are not affected by such contact. The glass-based compositions described herein may be selected to have liquidus viscosities that are compatible with fusion-draw processes and/or slot draw processes. Thus, the glass-based compositions described herein are compatible with existing forming methods, increasing the manufacturability of glass-based articles formed from the glass-based compositions.

As used herein, “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed herein is determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point”. As used herein, the “Vogel-Fulcher-Tamman” (VFT) relation describes the temperature dependence of the viscosity and is represented by the following equation:

$$log η = A + \frac{B}{T - {T}_{o}}$$

where η is viscosity. To determine VFT A, VFT B, and VFT To, the viscosity of the glass composition is measured over a given temperature range. The raw data of viscosity versus temperature is then fit with the VFT equation by least-squares fitting to obtain A, B, and Tₒ. With these values, a viscosity point (e.g., 200 Poise (P) Temperature, 35,000 P Temperature, and 200,000 P Temperature) at any temperature above softening point may be calculated. Unless otherwise specified, the liquidus viscosity and temperature of a glass composition or article is measured before the composition or article is subjected to any ion-exchange process or any other strengthening process. In particular, the liquidus viscosity and temperature of a glass composition or article is measured before the composition or article is exposed to an ion-exchange solution, for example before being immersed in an ion-exchange solution. As reported in the Examples below, the “liquidus viscosity” discussed herein corresponds to the “internal” Liquidus Viscosity (kP) reported in Table I.

In aspects, the liquidus viscosity of the glass-based composition can be 100 kiloPoise (kP) or more, 125 kP or more, 150 kP or more, 175 kP or more, 200 kP or more, 225 kP or more, 250 kP or more, 350 kP or less, 325 kP or less, 300 kP or less, or 275 kP or less. In aspects, the liquidus viscosity of the glass-based composition can be in a range from greater than or equal to 100 kP to less than or equal to 350 kP, from greater than or equal to 125 kP to less than or equal to 350 kP, from greater than or equal to 150 kP to less than or equal to 325 kP, from greater than or equal to 175 kP to less than or equal to 325 kP, from greater than or equal to 200 kP to less than or equal to 300 kP, from greater than or equal to 225 kP to less than or equal to 300 kP, or any range or subrange therebetween. In preferred aspects, the liquidus viscosity of the glass-based composition is in a range from greater than or equal to 100 kP to less than or equal to 350 kP, from 150 kP to 300 kP, or from 200 kP to 300 kP.

Contrary to the conventional expectation that lower liquidus viscosity has been associated with higher K_{IC} values and improved ion exchange capability, the Examples of the present disclosure demonstrate that a high fracture toughness (e.g., K_{IC} of 0.75 MPa√m or more) can be obtained simultaneously with a high liquidus viscosity (e.g., 100 kP or more, 150 kP or more, 175 kP or more, or from 200 kP to 300 kP). Without wishing to be bound by theory, it is believed that compositions of the present disclosure produced a different structure of the glass network that is associated with a non-spodumene crystal phase when the composition is crystalized, as discussed below.

In aspects, the glass-based compositions described herein may form glass-based articles that exhibit an amorphous microstructure and may be substantially free of crystals or crystallites. In other words, the glass-based articles formed from the glass compositions described herein may exclude glass-ceramic materials. Alternatively, in aspects, the glass-based articles can form glass-ceramics. In further aspects, the glass-ceramic can be found by heating an amorphous glass-based article to nucleate and/or grow crystallites. In further aspects, the glass-ceramics can comprise an anorthoclase crystal phase and/or a feldspar solid solution crystal phase. In even further aspects, a primary crystal phase (i.e., the crystal phase with the greatest vol % of the glass-ceramic) can be anorthoclase or a feldspar solid solution.

In aspects, the composition, glass-based substrate, and/or glass-based article can be crystallized by heating it at 1050° C. for 24 hours to form an anorthoclase crystal phase or a feldspar solid solution. In further aspects, the primary crystal phase (i.e., the crystal phase with the greatest vol % of the glass-ceramic) after the composition, glass-based substrate, and/or glass-based article is heated at 1050° C. for 24 hours can be anorthoclase or a feldspar solid solution.

In aspects, the glass-based composition may comprise a value of MgO+Li₂O−(CaO+SrO+Na₂O+K₂O) in mol % that can be 0 or less, −0.5 or less, −0.8 or less, −0.9 or less, −1 or less, 1.1 or less, −4 or more, −3 or more, −2.5 or more, −2 or more, −1.7 or more, −1.5 or more, or −1.2 or more. In aspects, the glass-based composition may comprise a value of MgO+Li₂O−(CaO+SrO+Na₂O+K₂O) in mol % that can be in a range from greater than or equal to −4 to less than or equal to 0, from greater than or equal to −4 to less than or equal to −0.5, from greater than or equal to −3 to less than or equal to −0.5, from greater than or equal to −2.5 to less than or equal to −0.8, from greater than or equal to −2 to less than or equal to −0.8, from greater than or equal to −1.7 to less than or equal to −0.9, from greater than or equal to −1.5 to less than or equal to −1, from greater than or equal to −1.3 to less than or equal to −1, or any range or subrange therebetween. In preferred aspects, the glass-based composition may comprise a value of MgO+Li₂O−(CaO+SrO+Na₂O+K₂O) in mol % from greater than or equal to −4 to less than or equal to 0, from greater than or equal to −4 to less than or equal to −0.5, or from greater than or equal to −1.5 to less than or equal to −1. Without wishing to be bound by theory, it is believed that when a value of MgO+Li₂O−(CaO+SrO+Na₂O+K₂O) (in mol %) is slightly negative (e.g., from −4 to −0.5 or from −1.5 to −1), the glass-based composition may crystallize into a non-spodumene primary crystal phase that can be associated with increased liquidus viscosity (e.g., 100 kP or more, 150 kP or more, 175 kP or more, from 200 kP to 300 kP), as discussed above.

Glass-based compositions according to aspects have a high fracture toughness. Without wishing to be bound by theory, the high fracture toughness may impart improved drop performance to the glass-based compositions. The high fracture toughness of the glass-based compositions described herein increases the resistance of the glass-based substrates to damage and allows a higher degree of stress to be imparted to the resulting glass-based articles through ion exchange, as characterized by central tension, without becoming frangible. As used herein, “fracture toughness” refers to the K_{IC} value as measured by the chevron notched short bar method unless otherwise noted. The chevron notched short bar (CNSB) method utilized to measure the K_{IC} value is disclosed in Reddy, K. P. R. et al., “Fracture Toughness Measurement of Glass and Ceramic Materials Using Chevron-Notched Specimens,” J. Am. Ceram. Soc., 71 [6], C-310-C-313 (1988) except that Y*m is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Additionally, the K_{IC} values are measured on non-strengthened glass-based samples, such as measuring the K_{IC} value prior to ion exchanging a glass-based substrate to form a glass-based article. The K_{IC} values discussed herein are reported in MPa√m, unless otherwise noted. In aspects, the glass-based compositions exhibit a K_{IC} value of greater than or equal to 0.75 MPa√m, such as greater than or equal to 0.76 MPa√m, greater than or equal to 0.77 MPa√m, greater than or equal to 0.8 MPa√m, or more. In aspects, the glass-based compositions exhibit a K_{IC} value of from greater than or equal to 0.75 MPa√m to less than or equal to 0.8 MPa√m, such as from greater than or equal to 0.76 MPa√m to less than or equal to 0.79 MPa√m, from greater than or equal to 0.77 to less than or equal to from 0.78 MPa√m, and all ranges and sub-ranges between the foregoing values.

Throughout the disclosure, volume electrical resistivity is measured in accordance with ASTM D257. Unless otherwise indicated, volume electrical resistivity is measured using a 16008B Resistivity Cell (Agilent Technologies). In aspects, a volume resistivity of the glass-based substrate and/or the glass-based article can be 2×10¹⁵ Ohm-centimeters or more, 5×10¹⁵ Ohm-centimeters or more, 7×10¹⁵ Ohm-centimeters or more, 1×10¹⁶ Ohm-centimeters or more, or 2×10¹⁶ Ohm-centimeters or more. In aspects, a volume resistivity of the glass-based substrate and/or the glass-based article can be in a range from greater than or equal to 2×10¹⁵ Ohm-centimeters to less than or equal to 5×10¹⁷ Ohm-centimeters, from greater than or equal to 5×10¹⁵ Ohm-centimeters to less than or equal to 2×10¹⁷ Ohm-centimeters, from greater than or equal to 1×10¹⁶ Ohm-centimeters to 1×10¹⁷ Ohm-centimeters, or any range or subrange therebetween. In preferred aspects, the volume electrical resistivity of the glass-based substrate can be from greater than or equal to 2×10¹⁵ Ohm-centimeters to less than or equal to 5×10¹⁷ Ohm-centimeters or from greater than or equal to 1×10¹⁶ Ohm-centimeters to less than or equal to 1×10¹⁷ Ohm-centimeters. Providing glass-based substrates and/or glass-based articles with a high volume electrical resistivity (e.g., 2×10¹⁵ Ohm-centimeters or more, or from 1×10¹⁶ Ohm-centimeters to 1×10¹⁷ Ohm-centimeters) can decrease an incidence of electrostatic discharge that can discolor or otherwise damage glass-based substrates and/or glass-based articles, especially when the dimensions of the glass-based substrate and/or glass-based article is larger (e.g., 10 cm or more, or 20 cm or more).

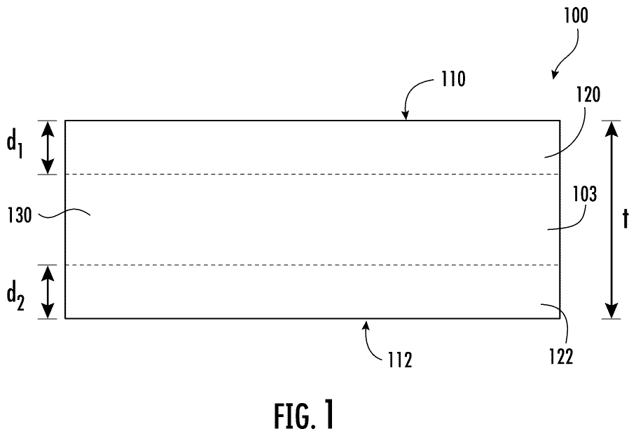

As shown in FIG. 1, a glass-based article 100 comprises a first major surface 110 and a second major surface 112 opposite the first major surface. In aspects, the first major surface 110 and/or the second major surface 112 can comprise a planar surface. In further aspects, the first major surface 110 can be parallel to the second major surface 112. As shown, a substrate thickness t of the glass-based article 100 is defined between the first major surface 110 and the second major surface 112 as the average thickness therebetween. In aspects, the substrate thickness t can be 0.02 mm or more, 0.05 mm or more, 0.1 mm or more, 0.2 mm or more, 0.4 mm or more, 0.5 mm or more, 0.6 mm or more, 0.7 mm or more, 5 mm or less, 3 mm or less, 2 mm or less, 1.5 mm or less, 1 mm or less, 0.9 mm or less, 0.8 mm or less, 0.7 mm or less, 0.5 mm or less, or 0.2 mm or less. In aspects, the substrate thickness t can be in a range from greater than or equal to 0.02 mm to less than or equal to 5 mm, from greater than or equal to 0.02 mm to less than or equal to 3 mm, from greater than or equal to 0.02 mm to less than or equal to 2 mm, from greater than or equal to 0.05 mm to less than or equal to 1.5 mm, from greater than or equal to 0.1 mm to less than or equal to 1.5 mm, from greater than or equal to 0.2 mm to less than or equal to 1 mm, from greater than or equal to 0.4 mm to less than or equal to 1 mm, from greater than or equal to 0.5 mm to less than or equal to 1 mm, from greater than or equal to 0.6 mm to less than or equal to 0.9 mm, from greater than or equal to 0.6 mm to less than or equal to 0.8 mm, or any range or subrange therebetween. In preferred aspects, the substrate thickness t of the glass-based article can be in a range from greater than or equal to 0.02 mm to less than or equal to 5 mm, from greater than or equal to 0.4 mm to less than or equal to 2 mm, or from greater than or equal to 0.5 mm to less than or equal to 2 mm. The glass-based substrate utilized to form the glass-based article may have the same thickness as the thickness desired for the glass-based article.

As used herein, the term “Knoop Scratch Test” is used to refer to a scratch test employed on various articles comprising a substrate, such as the articles of the disclosure, to ascertain the scratch resistance of the tested surface of the substrate. The Knoop Scratch Test is conducted by sliding a Knoop indenter on the exposed surface of a specimen (e.g., first major surface 110, second major surface 112). In particular, the test is conducted by sliding the Knoop indenter across the exposed surface at a rate of 24 mm/min at a pre-determined load, as measured by a Universal Material Tester. The Knoop indenter is a diamond-tipped, rhombic-based pyramid with 172° 30′ and 130° angles. Further, the Knoop Scratch Test is conducted by scratching the exposed surface of the sample at gradually increasing load levels until the specimen show signs of unacceptable damage. For each load level (e.g., in units of Newtons (N)), five (5) separate scratches are made according to the Knoop Scratch Test. A “Knoop Scratch Threshold,” as also used herein, is defined as the load level (i.e., as reported in Newtons (N)) employed during the Knoop Scratch Test at which the damage is greater than twice the scratch width for at least 20% of the scratch length. Further, the lowest load level (i.e., as reported in Newtons (N)) that generated this unacceptable damage on the specimen is defined as the Knoop Scratch Threshold.

In aspects, the glass-based article 100 (see FIG. 1) can comprise a Knoop Scratch Threshold from about 9N to about 18N upon testing with a Knoop Scratch Test. The glass-based article can also comprise a Knoop Scratch Threshold from greater than or equal to 18N to less than or equal to 22N upon testing with a Knoop Scratch Test. Accordingly, the glass-based article can be characterized by a Knoop Scratch Threshold of about 9N, 10N, 11N, 12N, 13N, 14N, 15N, 16N, 17N, 18N, 19N, 20N, 21N, 22N, and all threshold load levels between these amounts. In further aspects, the glass-based article can comprise a maximum crack width of about 200 μm upon testing with a Knoop Scratch Test. As used herein, the terms “maximum crack width” or “average maximum crack width” are used interchangeably and refer to the average maximum width of the cracks observed in a group of samples tested with the Knoop Scratch Test at the Knoop Scratch Threshold (N). Hence, the average maximum crack width is measured on a group of samples upon reaching the Knoop Scratch Threshold.

The Flat Face Drop Test simulates field sharp contact damage (e.g., from real world rough surfaces like granite, asphalt, etc.) by dropping samples on a sheet of 180 grit alumina. Using the sheet of 180 grit alumina, controlled test data can be generated so that one can make a fair comparison between sample of interest and comparative samples. The sheet of alumina was changed every test sample enabling consistency. The test part was mounted on a commercially available drop test machine (Yoshida Seiki drop tester, Model-DT-205H, manufactured by Shinyei Technology Co, Japan) and aligned flat to the drop surface (sheet of 180 grit alumina). The drop height was sequentially increased by 10 cm increment from a start height of 22 cm until the test sample failed (i.e., crack on the display area of the screen protector) and the corresponding failure height was noted. 10 samples per condition are tested and the average failure height was calculated.

In aspects, the glass-based article can withstand a height in the Flat Face Drop Test of 100 cm or more, 110 cm or more, 120 cm or more, 130 cm or more, 140 cm or more, 250 cm or less, 220 cm or less, 200 cm or less, 180 cm or less, 170 cm or less, or 160 cm or less. In aspects, the glass-based article can withstand a height in the Flat Face Drop Test can be in a range from greater than or equal to 100 cm to less than or equal to 250 cm, from greater than or equal to 110 cm to less than or equal to 220 cm, from greater than or equal to 120 cm to less than or equal to 200 cm, from greater than or equal to 130 cm to less than or equal to 180 cm, from greater than or equal to 140 cm to less than or equal to 170 cm, or any range or subrange therebetween.

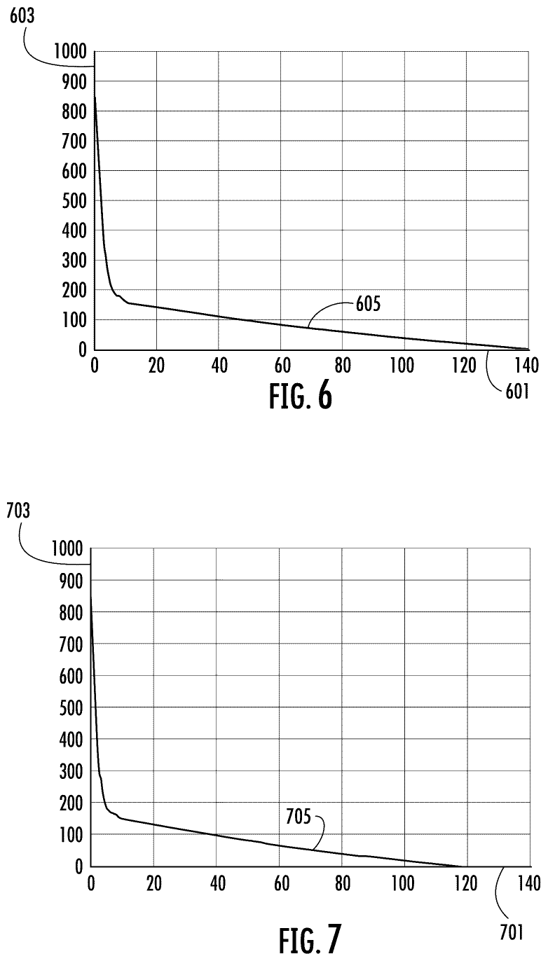

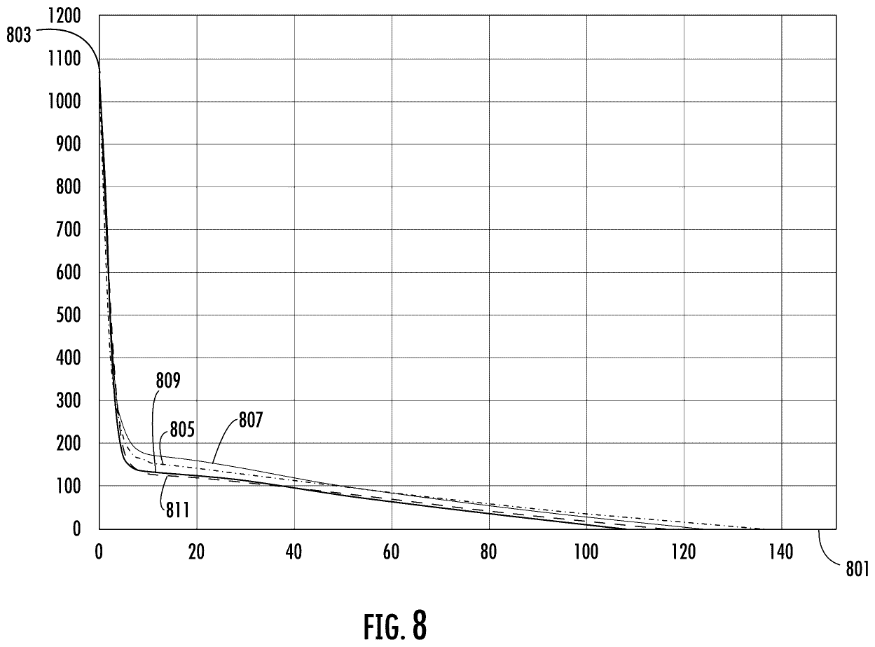

As mentioned above, in aspects, the glass compositions (e.g., glass-based substrate) described herein can be strengthened, such as by ion exchange, making a glass-based article that is damage resistant for applications such as, but not limited to, display covers. As shown in FIG. 1, the glass-based article 100 has a first compressive stress region 120 extending from the first major surface 110 to a first depth of compression d1, and/or the glass-based article 100 has a second compressive stress region 122 extending from the second major surface 112 to a second depth of compression d2. The first compressive stress region and/or the second compressive stress region is under compressive stress (e.g., as a result of ion exchange). In further aspects, as shown in FIG. 1, the glass-based article 100 can comprise a central tension region 130 under tensile stress (e.g., central tension (CT)) and positioned between the first compressive stress region 120 and the second compressive stress region 122 (e.g., extending between the first depth of compression d1 from the first major surface 110 and the second depth of compression d2 from the second major surface 112). As used herein, “depth of compression” (DOC) refers to the depth at which the stress within the glass-based article changes from compressive to tensile. At the DOC, the stress crosses from a positive (compressive) stress to a negative (tensile) stress and thus exhibits a stress value of zero. According to the convention normally used in the art and in FIGS. 6-7, compression or compressive stress is expressed as a positive (>0) stress and tension or tensile stress is expressed as a negative (<0) stress. Throughout this description, however, CS and CT are both expressed as positive or absolute values—i.e., as recited herein, CS=|CS|. The compressive stress (CS) has a maximum at or near the surface of the glass-based article, and the CS varies with distance d from the surface according to a function.

In aspects, the compressive stress region(s) may be created by chemically strengthening a glass-based substrate to form the glass-based article 100. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the substrate can enable small (e.g., smaller than about 10 mm or less) bend radii because the compressive stress from the chemical strengthening can counteract the bend-induced tensile stress on the outermost surface of the substrate (e.g., first major surface 110, or second major surface 112). Depth of compression (DOC) may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure a depth of compression. Unless specified otherwise, compressive stress (including surface CS) is measured by a surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 75 μm, SCALP is used to measure the depth of compression and central tension (CT). Where the stress in the substrate is generated by exchanging both potassium and sodium ions into the glass, and the article being measured is thicker than about 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than about 75 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the first depth of compression and/or second depth of compression, as a percentage of the substrate thickness t, can be about 17% or more, about 18% or more, about 19% or more, about 20% or more, about 21% or more, about 22% or more, about 23% or more, about 24% or more, about 25% or more, about 25% or less, about 24% or less, or about 23% or less. In even further aspects, the first depth of compression and/or the second depth of compression, as a percentage of the substrate thickness t, can be in a range from about 17% to about 25%, from about 18% to about 25%, from about 19% to about 25%, from about 20% to about 25%, from about 21% to about 24%, from about 22% to about 23%, or any range or subrange therebetween. In aspects, the first depth of compression and/or the second depth of compression can be about 10 μm or more, about 30 μm or more, about 50 μm or more, about 100 μm or more, about 150 μm or more, about 200 μm or more, about 250 μm or more, about 500 μm or less, about 400 μm or less, about 300 μm or less, about 250 μm or less, about 200 μm or less, about 150 μm or less, or about 100 μm or less. In aspects, the first depth of compression and/or the second depth of compression can be in a range from greater than or equal to 10 μm to less than or equal to 500 μm, from greater than or equal to 30 μm to less than or equal to 400 μm, from greater than or equal to 50 μm to less than or equal to 300 μm, from greater than or equal to 100 μm to less than or equal to 250 μm, from greater than or equal to 150 μm to less than or equal to 200 μm, or any range or subrange therebetween. In aspects, the first depth of compression and/or the second depth of compression can be about 150 μm or more, for example, in a range from greater than or equal to 150 μm to less than or equal to 500 μm, from greater than or equal to 200 μm to less than or equal to 400 μm, or any range or subrange therebetween. In aspects, the first depth of compression can be greater than, less than, or substantially the same as the second depth of compression. By providing a glass-based substrate and/or a ceramic-based substrate comprising a first depth of compression and/or a second depth of compression in a range from about 20% to about 25% of the substrate thickness, good impact and/or puncture resistance can be enabled.

The first compressive stress region 120 comprises a maximum first compressive stress, and/or the second compressive stress region 122 comprises a maximum second compressive stress. In aspects, a location of the maximum first compressive stress and/or the maximum second compressive stress can be at (e.g., within about 1 μm) of the corresponding major surface, although the corresponding maximum compressive stress can be located more than 1 μm from the corresponding major surface. In aspects, the maximum first compressive stress and/or the maximum second compressive stress can be about 100 MegaPascals (MPa) or more, about 300 MPa or more, about 500 MPa or more, about 600 MPa or more, about 700 MPa or more, about 800 MPa or more, about 1,500 MPa or less, about 1,200 MPa or less, about 1,000 MPa or less, or about 900 MPa or less. In aspects, the maximum first compressive stress and/or the maximum second compressive stress can be in a range from greater than or equal to 100 MPa to less than or equal to 1,500 MPa, from greater than or equal to 300 MPa to less than or equal to 1,200 MPa, from greater than or equal to 500 MPa to less than or equal to 1,000 MPa, from greater than or equal to 600 MPa to less than or equal to 1,000 MPa, from greater than or equal to 800 MPa to less than or equal to 1.00 MPa, or any range or subrange therebetween. Providing a maximum first compressive stress and/or a maximum second compressive stress in a range from about 500 MPa to about 1,500 MPa or from about 500 MPa to about 1,000 MPa can enable good impact and/or puncture resistance.

In aspects, Na⁺ and/or K⁺ ions can be exchanged into the glass-based article, and the Na⁺ ions diffuse to a deeper depth into the glass-based article than the K⁺ ions. The depth of penetration of K⁺ ions (“Potassium DOL” or “DOL” herein) is distinguished from DOC because it represents the depth of potassium penetration as a result of an ion exchange process. The Potassium DOL is typically less than the DOC for the articles described herein. Potassium DOL is measured using a surface stress meter such as the commercially available FSM-6000 surface stress meter, manufactured by Orihara Industrial Co., Ltd. (Japan), which relies on accurate measurement of the stress optical coefficient (SOC), as described above with reference to the CS measurement. The potassium DOL may define a depth of a compressive stress spike (DOL_{SP}), where a stress profile transitions from a steep spike region to a less-steep deep region.

The deep region extends from the bottom of the spike to the depth of compression. In aspects, the depth of layer of one or more of the alkali metal ions associated with the corresponding compressive stress region (e.g., DOL_{SP}) of the glass-based article can be 3 μm or more, 4 μm or more, 5 μm or more, 6 μm or more, 7 μm or more, 10 μm or less, 9 μm or less, 8 μm or less, or 7 μm or less. In aspects, the depth of layer of one or more of the alkali metal ions associated with the corresponding compressive stress region (e.g., DOL_{SP}) can be in a range from 3 μm to 10 μm, from 4 μm to 9 μm, from 5 μm to 8 μm, from 6 μm to 7 μm, or any range or subrange therebetween. In aspects, a ratio of the depth of layer (e.g., DOL_{SP}) to the depth of compression (e.g., DOC) can be about 0.02 or more, about 0.025 or more, about 0.03 or more, about 0.035 or more, about 0.04 or more, about 0.08 or less (e.g., about 0.080 or less), about 0.07 or less (e.g., about 0.070 or less), about 0.06 or less (e.g., about 0.060 or less), about 0.055 or less, about 0.05 or less, about 0.045 or less, about 0.04 or less, about 0.35 or less, or about 0.03 or less. In aspects, a ratio of the depth of layer (e.g., DOL_{SP}) to the depth of compression (e.g., DOC) can be in a range from greater than or equal to 0.02 to less than or equal to 0.08, from greater than or equal to 0.02 to less than or equal to 0.07, from greater than or equal to 0.02 to less than or equal to 0.06, from greater than or equal to 0.02 to less than or equal to 0.055, from greater than or equal to 0.02 to less than or equal to 0.05, from greater than or equal to 0.025 to less than or equal to 0.045, from greater than or equal to 0.03 to less than or equal to 0.04, or any range or subrange therebetween. In preferred aspects, a ratio of the depth of layer (e.g., DOL_{SP}) to the depth of compression (e.g., DOC) can be in a range from greater than or equal to 0.02 to less than or equal to 0.06, from greater than or equal to 0.04 to less than or equal to 0.06, or from 0.045 to less than or equal to 0.060.

As discussed in the previous paragraph, the compressive stress layer can comprise a depth of the compressive stress spike (DOL_{SP}), where a stress profile transitions from a steep spike region to a less-steep deep region. In aspects, a compressive stress at the depth of the compressive stress spike can be about 90 MPa or more, about 100 MPa or more, about 125 MPa or more, about 150 MPa or more, about 175 MPa or more, about 300 MPa or less, about 250 MPa or less, about 225 MPa or less, about 210 MPa or less, about 200 MPa or less, about 175 MPa or less, about 150 MPa or less, or about 125 MPa or less. In aspects, a compressive stress at the depth of the compressive stress spike can be in a range from greater than or equal to 90 MPa to less than or equal to 300 MPa, from greater than or equal to 100 MPa to less than or equal to 250 MPa, from greater than or equal to 125 MPa to less than or equal to 225 MPa, from greater than or equal to 125 MPa to less than or equal to 210 MPa, from greater than or equal to 150 MPa to less than or equal to 200 MPa, or any range or subrange therebetween. In aspects, a ratio of the compressive stress at the depth of the compressive stress spike to the corresponding maximum compressive stress can be about 0.08 or more, about 0.10 or more, about 0.12 or more, about 0.15 or more, about 0.18 or more, about 0.19 or more, about 0.20 or more, about 0.21 or more, about 0.22 or more, about 0.25 or less, about 0.24 or less, about 0.23 or less, about 0.22 or less, or about 0.20 or less. In aspects, a ratio of the compressive stress at the depth of the compressive stress spike to the corresponding maximum compressive stress can be in a range from greater than or equal to 0.08 to less than or equal to 0.25, from greater than or equal to 0.10 to less than or equal to 0.25, from greater than or equal to 0.12 to less than or equal to 0.25, from greater than or equal to 0.15 to less than or equal to 0.25, from greater than or equal to 0.18 to less than or equal to 0.25, from greater than or equal to 0.19 to less than or equal to 0.24, from greater than or equal to 0.20 to less than or equal to 0.23, from greater than or equal to 0.21 to less than or equal to 0.22, or any range or subrange therebetween. In preferred aspects, the a ratio of the compressive stress at the depth of the compressive stress spike to the corresponding maximum compressive stress can be in a range from greater than or equal to 0.10 to less than or equal to 0.25 or from greater than or equal to 0.10 to less than or equal to 0.20. The ratio of the depth of layer (e.g., DOL_{SP}) to the depth of compression (e.g., DOC) within one or more of the corresponding ranges in the previous paragraph in combination with the ratio of the compressive stress at the depth of the compressive stress spike to the corresponding maximum compressive stress within one or more of the range in this paragraph can be a characteristic of the compositions of the present disclosure, which may be distinctive from other compositions.

In aspects, a slope of the spike region (e.g., from a major surface to the depth of the compressive stress spike) can be −300 MPa/μm or more, −250 MPa/μm or more, −220 MPa/μm or more, −200 MPa/μm or more, −190 MPa/μm or more, −100 MPa/μm or less, −130 MPa/μm or less, −150 MPa/μm or less, or −160 MPa/μm or less. In aspects, a slope of the spike region (e.g., from a major surface to the depth of the compressive stress spike) can be in a range from greater than or equal to −300 MPa/μm to less than or equal to −300 MPa/μm, from greater than or equal to −250 MPa/μm to less than or equal to −100 MPa/μm, from greater than or equal to −220 MPa/μm to less than or equal to −130 MPa/μm, from greater than or equal to −200 MPa/μm to less than or equal to −150 MPa/μm, from greater than or equal to −190 MPa/μm to less than or equal to −160 MPa/μm, or any range or subrange therebetween. In aspects, a slope of the deep region (e.g., deeper than the depth of the compressive stress spike) can be about −2.0 MPa/μm or more, −1.8 MPa/μm −1.7 MPa/μm or more, −1.6 MPa/μm or more, −0.8 MPa/μm or more, −1.0 MPa/μm or more, −1.1 MPa/μm or more, or −1.2 MPa/μm or more. In aspects, a slope of the deep region (e.g., deeper than the depth of the compressive stress spike) can be in a range from greater than or equal to −2.0 MPa/μm to less than or equal to −0.8 MPa/μm, from greater than or equal to −2.0 MPa/μm to less than or equal to −1.0 MPa/μm, from greater than or equal to −1.8 MPa/μm to less than or equal to −1.1 MPa/μm, from greater than or equal to −1.7 MPa/μm to less than or equal to −1.1 MPa/μm, from greater than or equal to −1.6 MPa/μm to less than or equal to −1.5 MPa/μm, or any range or subrange therebetween.

The central tension region can comprise a maximum central tension (maximum CT). The measurement of a maximum CT value is an indicator of the total amount of stress stored in the strengthened articles. For this reason, the ability to achieve higher CT values correlates to the ability to achieve higher degrees of strengthening and increased performance. In aspects, the maximum CT can be 50 MPa or more, 60 MPa or more, 70 MPa or more, 75 MPa or more, 80 MPa or more, 85 MPa or more, 120 MPa or less, 100 MPa or less, 95 MPa or less, 90 MPa or less, 85 MPa or less, or 80 MPa or less. In aspects, the maximum CT can be in a range from greater than or equal to 50 MPa to less than or equal to 120 MPa, from greater than or equal to 50 MPa to less than or equal to 100 MPa, from greater than or equal to 50 MPa to less than or equal to 95 MPa, from greater than or equal to 60 MPa to less than or equal to 90 MPa, from greater than or equal to 70 MPa to less than or equal to 90 MPa, from greater than or equal to 75 MPa to less than or equal to 85 MPa, from greater than or equal to 80 MPa to less than or equal to 85 MPa, or any range or subrange therebetween. In preferred aspects, the maximum CT can be in a range from greater than 50 MPa to less than or equal to 120 MPa, from greater than or equal to 50 MPa to less than or equal to 100 MPa, or from greater than or equal to 70 MPa to less than or equal to 100 MPa.

The high fracture toughness values of the glass compositions described herein also may enable improved performance. The frangibility limit of the glass-based articles produced utilizing the glass compositions described herein is dependent at least in part on the fracture toughness. For this reason, the high fracture toughness of the glass compositions described herein allows for a large amount of stored strain energy to be imparted to the glass-based articles formed therefrom without becoming frangible. The increased amount of stored strain energy that may then be included in the glass-based articles allows the glass-based articles to exhibit increased fracture resistance, which may be observed through the drop performance of the glass-based articles. The relationship between the frangibility limit and the fracture toughness is described in U.S. Patent Application Pub. No. 2020/0079689 A1, titled “Glass-based Articles with Improved Fracture Resistance,” published Mar. 12, 2020, the entirety of which is incorporated herein by reference. The relationship between the fracture toughness and drop performance is described in U.S. Patent Application Pub. No. 2019/0369672 A1, titled “Glass with Improved Drop Performance,” published Dec. 5, 2019, the entirety of which is incorporated herein by reference.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent the front surface of the housing. The consumer electronic product can comprise a cover substrate disposed over the display. In aspects, at least one of a portion of the housing or the cover substrate comprises the coating and/or coated article discussed throughout the disclosure. The display can comprise a liquid crystal display (LCD), an electrophoretic displays (EPD), an organic light-emitting diode (OLED) display, or a plasma display panel (PDP). In aspects, the consumer electronic product can be a portable electronic device, for example, a smartphone, a tablet, a wearable device, or a laptop.

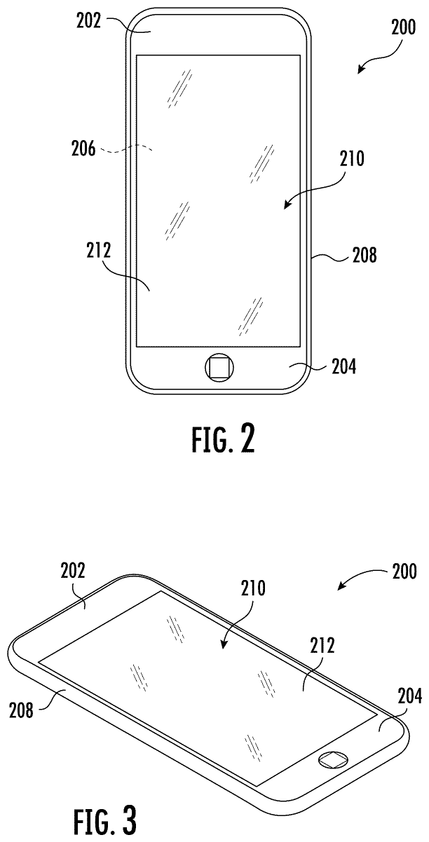

The coated article and/or coating disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion-resistance or a combination thereof. An exemplary article incorporating any of the coated articles disclosed herein is shown in FIGS. 2 and 3. Specifically, FIGS. 2 and 3 show a consumer electronic device 200 including a housing 202 having a front surface 204, a back surface 206, and side surfaces 208. The consumer electronic device 200 can comprise electrical components (not shown) that are at least partially inside or entirely within the housing and including at least a controller, a memory, and a display 210 at or adjacent to the front surface of the housing. The consumer electronic device 200 can comprise a cover substrate 212 at or over the front surface of the housing such that it is over the display. In aspects, at least one of the cover substrate 212 or a portion of housing 202 may include a substrate with the first major surface and/or the coated article disclosed herein.

Methods of making glass-based article of the present disclosure will now be discussed with reference to FIGS. 1 and 4-5. As discussed above, glass-based substrates comprising compositions in accordance with the present disclosure can be obtained by forming them with a variety of ribbon forming processes, for example, slot draw, down-draw, fusion down-draw, up-draw, press roll, redraw, or float. Alternatively, glass-based substrates comprising compositions in accordance with the present disclosure may be obtained by purchase. In aspects, the glass-based substrate can be an amorphous substrate or a glass-ceramic. In further aspects, a glass-ceramic can be formed by heating a glass-based substrate to nucleate and/or grow crystals. As discussed above, glass-ceramics in accordance with the present disclosure can comprise anorthoclase or a feldspar solid solution, for example, a primary crystal phase.

In aspects, the glass-based substrate can be chemically strengthened by exposing the glass-based substrate to one or more ion-exchange medium(s) (e.g., molten salt solutions). The exchange medium(s) can include a molten nitrate salt (e.g., KNO₃, NaNO₃, or combinations thereof), for example, as a molten salt solution, although other sodium salts and/or potassium salts may be used in the ion-exchange medium, such as, for example sodium or potassium nitrites, phosphates, or sulfates. In aspects, the ion-exchange medium may include lithium salts, such as LiNO₃. The ion-exchange medium may additionally include additives commonly included when ion exchanging glass, such as silicic acid. In aspects, the ion-exchange medium may include a mixture of sodium and potassium (e.g., including both NaNO₃ and KNO₃). In aspects, the ion-exchange medium may include any combination NaNO₃ and KNO₃ in the amounts described below, such as a molten salt bath containing 80 wt % NaNO₃ and 20 wt % KNO₃, a molten salt bath containing 70 wt % NaNO₃ and 30 wt % KNO₃, a molten salt bath containing 60 wt % NaNO₃ and 40 wt % KNO₃, a molten salt bath containing 50 wt % NaNO₃ and 50 wt % KNO₃, a molten salt bath containing 40 wt % NaNO₃ and 60 wt % KNO₃, or any range or subrange therebetween.

In aspects, the ion-exchange medium comprises NaNO₃. The sodium in the ion-exchange medium exchanges with lithium ions in the glass to produce a compressive stress. In aspects, the ion-exchange medium may include NaNO₃ in an amount of 95 wt % or less, 90 wt % or less, 80 wt % or less, 70 wt % or less, 60 wt % or less, 50 wt % or less, 40 wt % or less, 30 wt % or less, 20 wt % or less, 10 wt % or less, 5 wt % or more, 10 wt % or more, 20 wt % or more, 30 wt % or more, 40 wt % or more, 50 wt % or more, 60 wt % or more, 70 wt % or more, 80 wt % or more, or 90 wt % or more. In aspects, the ion-exchange medium may include NaNO₃ in an amount from greater than or equal to 0 wt % to less than or equal to 100 wt %, from greater than or equal to 10 wt % to less than or equal to 90 wt %, from greater than or equal to 20 wt % to less than or equal to 80 wt %, from greater than or equal to 30 wt % to less than or equal to 70 wt %, from greater than or equal to 40 wt % to less than or equal to 60 wt %, or any range or subrange therebetween. In aspects, the molten ion-exchange medium includes 100 wt % NaNO₃.

In aspects, the ion-exchange medium comprises KNO₃. In aspects, the ion-exchange medium may include KNO₃ in an amount of 95 wt % or less, 90 wt % or less, 80 wt % or less, 70 wt % or less, 60 wt % or less, 50 wt % or less, 40 wt % or less, 30 wt % or less, 20 wt % or less, 10 wt % or less, 5 wt % or more, 10 wt % or more, 20 wt % or more, 30 wt % or more, 40 wt % or more, 50 wt % or more, 60 wt % or more, 70 wt % or more, 80 wt % or more, or 90 wt % or more. In aspects, the ion-exchange medium may include KNO₃ in an amount from 0 wt % to 100 wt %, from greater than or equal to 10 wt % to less than or equal to 90 wt %, from greater than or equal to 20 wt % to less than or equal to 80 wt %, from greater than or equal to 30 wt % to less than or equal to 70 wt %, from greater than or equal to 40 wt % to less than or equal to 60 wt %, or any range or subrange therebetween. In aspects, the molten ion-exchange medium includes 98 wt % KNO₃, 99 wt % KNO₃, or 100 wt % KNO₃.

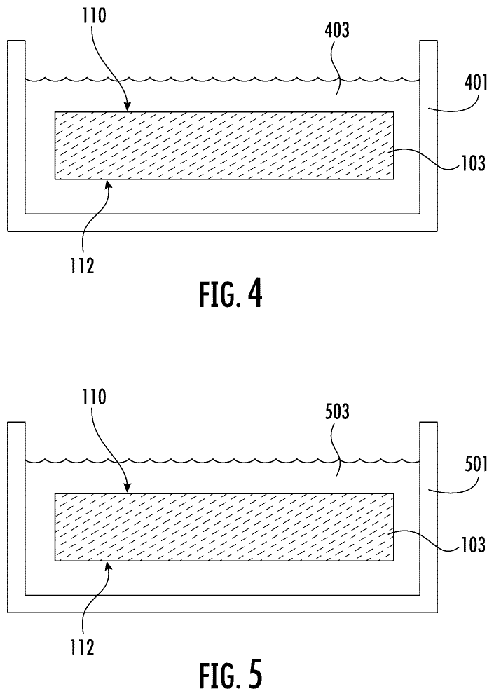

In aspects, as shown in FIG. 4, the glass-based substrate 103 can be exposed to a molten salt solution 403 (e.g., contained in a salt bath 401), for example, by immersing the glass-based substrate 103 in the molten salt solution 403. Alternatively, although not shown, can comprise spraying the ion-exchange medium onto a glass substrate made from the glass composition or otherwise physically applying the ion-exchange medium to the glass-based to form the ion-exchanged glass-based article. In further aspects, the ion-exchange medium (e.g., molten salt solution 403) can be maintained at a predetermined temperature and/or the glass-based substrate 103 can be in contact with the ion-exchange medium (e.g., molten salt solution 403) for a predetermined period of time. In further aspects, the predetermined temperature can be about 350° C. or more, about 360° C. or more, about 370° C. or more, about 380° C. or more, about 390° C. or more, about 400° C. or more, about 410° C. or more, about 420° C. or more, about 430° C. or more, about 440° C. or more, about 500° C. or less, about 480° C. or less, about 470° C. or less, about 460° C. or less, about 450° C. or less, about 440° C. or less, or about 430° C. or less. In further aspects, the predetermined temperature can be in a range from greater than or equal to 350° C. to less than or equal to 500° C., from greater than or equal to 360° C. to less than or equal to 500° C., from greater than or equal to 370° C. to less than or equal to 490° C., from greater than or equal to 380° C. to less than or equal to 480° C., from greater than or equal to 390° C. to less than or equal to 470° C., from greater than or equal to 390° C. to less than or equal to 460° C., from greater than or equal to 400° C. to less than or equal to 450° C., from greater than or equal to 400° C. to less than or equal to 440° C., from greater than or equal to 410° C. to less than or equal to 440° C., or any range or subrange therebetween. In further aspects, the predetermined period of time can be about 5 minutes or more, 10 minutes or more, 0.25 hours or more, about 0.5 hours or more, about 1 hour or more, about 2 hours or more, about 4 hours or more, about 24 hours or less, about 8 hours or less, about 4 hours or less, about 3 hours or less, or about 2 hours or less. In aspects, the predetermined period of time can be in a range from greater than or equal to 5 minutes to less than or equal to 24 hours, from greater than or equal to 10 minutes to less than or equal to 24 hours, from greater than or equal to 0.25 hours to less than or equal to 8 hours, from greater than or equal to 0.5 hours to less than or equal to 8 hours, from greater than or equal to 1 hour to less than or equal to 4 hours, or any range or subrange therebetween.

In aspects, the ion exchange process may include a second ion exchange treatment. In further aspects, the second ion exchange treatment may include ion exchanging the glass-based article in a second molten salt bath. For example, as shown in FIG. 5, the glass-based substrate 103 the glass-based substrate 103 can be exposed to a second molten salt solution 503 (e.g., contained in a second salt bath 501), for example, by immersing the glass-based substrate 103 in the second molten salt solution 503. The second ion exchange treatment may utilize any of the ion-exchange mediums described herein. In aspects, the second ion exchange treatment utilizes a second molten salt bath that includes KNO₃.

The ion exchange process may be performed in an ion-exchange medium under processing conditions that provide an improved compressive stress profile as disclosed, for example, in U.S. Patent Application Publication No. 2016/0102011, which is incorporated herein by reference in its entirety. In aspects, the ion exchange process may be selected to form a parabolic stress profile in the glass-based articles, such as those stress profiles described in U.S. Patent Application Publication No. 2016/0102014, which is incorporated herein by reference in its entirety.

After an ion exchange process is performed, it should be understood that a composition at the surface of an ion-exchanged glass-based article can be different than the composition of the as-formed glass substrate (i.e., the glass substrate before it undergoes an ion exchange process). This results from one type of alkali metal ion in the as-formed glass substrate, such as, for example Li⁺ or Na⁺, being replaced with larger alkali metal ions, such as, for example Na⁺ or K⁺, respectively. However, the glass composition at or near the center of the depth of the glass-based article will, in aspects, still have the composition of the as-formed non-ion-exchanged glass substrate utilized to form the glass-based article. As utilized herein, the center of the glass-based article refers to any location in the glass-based article that is a distance of at least 0.5t from every surface thereof, where t is the thickness of the glass-based article.

### Examples

Embodiments will be further clarified by the following examples. It should be understood that these examples are not limiting to the aspects described above.

Glass compositions were prepared and analyzed. The analyzed glass compositions included the components listed in Table I below and were prepared by conventional glass forming methods. As mentioned above, the compositions reported herein (including Table I) refer to the composition of the resulting glass-based substrate. Composition 1 was a produced in a production-scale manufacturing process while Compositions 2-9 were produced in a lab-scale crucible manufacturing process. In Table I, all components are in mol %, and the K_{IC} fracture toughness was measured with the double cantilever beam (DCB) procedure, as described in the next paragraph. Alternatively, the K_{IC} fracture toughness can also be measured with the chevron notch (CNSB) method described herein. The Poisson's ratio (v), the Young's modulus (E), and the shear modulus (G) of the glass compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.” The refractive index at 589.3 nm and stress optical coefficient (SOC) of the substrates are also reported in Table I. The density of the glass compositions was determined using the buoyancy method of ASTM C693-93(2013).

For the DCB procedure, the DCB specimen geometry is shown in FIG. 7 with parameters being the crack length a, applied load P, cross-sectional dimensions w and 2h, and the thickness of the crack-guiding groove b. The samples were cut into rectangles of width 2h=1.25 cm and a thickness ranging from, w=0.3 mm to 1 mm, with the overall length of the sample, which is not a critical dimension, varying from 5 cm to 10 cm. A hole was drilled on both ends with a diamond drill to provide a means of attaching the sample to a sample holder and to the load. A crack “guiding groove” was cut down the length of the sample on both flat faces using a wafer dicing saw with a diamond blade, leaving a “web” of material, approximately half the total plate thickness (dimension b in FIG. 7), with a height of 180 μm corresponding to the blade thickness. The high precision dimensional tolerances of the dicing saw allow for minimal sample-to-sample variation. The dicing saw was also used to cut an initial crack where a=15 mm. As a consequence of this final operation a very thin wedge of material was created near the crack tip (due to the blade curvature) allowing for easier crack initiation in the sample. The samples were mounted in a metal sample holder with a steel wire in the bottom hole of the sample. The samples were also supported on the opposite end to keep the samples level under low loading conditions. A spring in series with a load cell (FUTEK, LSB200) was hooked to the upper hole which was then extended, to gradually apply load, using rope and a high precision slide. The crack was monitored using a microscope having a 5 μm resolution attached to a digital camera and a computer. The applied stress intensity, K_{P}, was calculated using the following equation:

$${K}_{P} = [ \frac{P \cdot a}{{( w \cdot b )}^{0.5} {h}^{1.5}} ] [ 3.47 + 2.32 \frac{h}{a} ]$$

For each sample, a crack was first initiated at the tip of the web, and then the starter crack was carefully sub-critically grown until the ratio of dimensions a/h was greater than 1.5 to accurately calculate stress intensity. At this point the crack length, a, was measured and recorded using a traveling microscope with 5 m resolution. A drop of toluene was then placed into the crack groove and wicked along the length of the groove by capillary forces, pinning the crack from moving until the fracture toughness is reached. The load was then increased until sample fracture occurred, and the critical stress intensity K_{IC} calculated from the failure load and sample dimensions, with Kₚ being equivalent to K_{IC} due to the measurement method.

The term “annealing point,” as used herein, refers to the temperature at which the viscosity of the glass composition is 1×10¹¹³¹⁸ poise. The term “strain point,” as used herein, refers to the temperature at which the viscosity of the glass composition is 1×10^{14.68} poise. The strain point and annealing point of the glass compositions was determined using the fiber elongation method of ASTM C336-71(2015) or the beam bending viscosity (BBV) method of ASTM C598-93(2013).

The term “softening point,” as used herein, refers to the temperature at which the viscosity of the glass composition is 1×10^{7.6} poise. The softening point of the glass compositions was determined using the fiber elongation method of ASTM C336-71(2015) or a parallel plate viscosity (PPV) method which measures the viscosity of inorganic glass from 10⁷ to 10⁹ poise as a function of temperature, similar to ASTM C1351M.

The linear coefficient of thermal expansion (CTE) over the temperature range 0-300° C. is expressed in terms of ppm/° C. and was determined using a push-rod dilatometer in accordance with ASTM E228-11.

TABLE I

| | | | | |
|---|---|---|---|---|
| Composition | 1 | 2 | 3 | 4 |

| SiO₂ | | 64.51 | 64.57 | 64.79 | 64.48 |
|---|---|---|---|---|---|
| Al₂O₃ | | 15.45 | 15.43 | 15.44 | 15.44 |
| P₂O₅ | | 1.16 | 1.18 | 1.06 | 1.28 |
| B₂O₃ | | 3.33 | 3.41 | 3.42 | 3.42 |
| MgO | | 0.52 | 0.52 | 0.52 | 0.52 |
| CaO | | 1.43 | 1.47 | 1.46 | 1.47 |
| SrO | | 1.07 | 1.07 | 1.08 | 1.05 |
| Li₂O | | 6.60 | 6.50 | 6.62 | 6.29 |
| Na₂O | | 5.29 | 5.24 | 5.05 | 5.37 |
| K₂O | | 0.41 | 0.38 | 0.33 | 0.44 |
| TiO₂ | | 0.16 | 0.17 | 0.17 | 0.17 |
| SnO₂ | | 0.05 | 0.05 | 0.05 | 0.05 |
| Fe₂O₃ | | 0.02 | 0.00 | 0.00 | 0.00 |
| Li₂O/Na₂O | | 1.25 | 1.24 | 1.31 | 1.17 |
| Al₂O₃ − R₂O − RO | | 0.13 | 0.25 | 0.38 | 0.30 |
| MgO + Li₂O − | | −1.08 | −1.14 | −0.80 | −1.52 |
| (CaO + SrO + Na₂O + K₂O) | | | | | |
| Density (g/cm³) | | 2.408 | 2.414 | 2.413 | 2.412 |
| CTE 0-300° C. | | 60.6 | | | |
| (ppm/° C.) | | | | | |
| Fiber | Strain | 572 | | | |
| Elongation | Point | | | | |
| | (° C.) | | | | |
| | Annealing | 625 | | | |
| | Point | | | | |
| | (° C.) | | | | |
| | Softening | 876.8 | | | |
| | Point | | | | |
| | (° C.) | | | | |
| Young's Modulus | | 77.3 | | | |
| (GPa) | | | | | |
| Shear Modulus | | 31.8 | | | |
| (GPa) | | | | | |
| Poisson's ratio | | 0.216 | | | |
| CNSB | K_{IC} | | | | |
| K_{IC} | (MPa · m^{0.5}) | | | | |
| | St. Deviation | | | | |
| DCB | K_{IC} | 0.812 | | | |
| K_{IC} | (MPa · m^{0.5}) | | | | |
| | St. Deviation | 0.018 | | | |
| Refractive Index | | 1.5082 | | | |
| Stress Optical Coefficient | | 3.07 | | | |
| VFT | A | −3.320 | −3.292 | −3.310 | −3.324 |
| Parameters | B | 8565.3 | 8362.9 | 8417.5 | 8508.1 |
| | Tₒ | 87.9 | 109.6 | 101.6 | 94.6 |
| Liquidus | Air | 1070 | 1095 | 1125 | 1090 |
| Temperature | Internal | 1065 | 1090 | 1110 | 1095 |
| (° C.) | Platinum | 1040 | 1090 | 1105 | 1095 |
| | Primary | Anorthoclase | Spodumene | | Feldspar |
| | Phase | | | | Solid- |
| | | | | | Solution |
| | Secondary | Spodumene | Feldspar | | Spodumene |
| | Phase | | Solid- | | |
| | | | Solution | | |
| Liquidus | Air | 252 | 157 | 82 | 167 |
| Viscosity | Internal | 279 | 173 | 109 | 152 |
| (kP) | Platinum | 475 | 173 | 120 | 152 |

| Composition | | 5 | 6 | 7 | 8 | 9 |
|---|---|---|---|---|---|---|
| SiO₂ | | 62.56 | 63.33 | 63.79 | 64.35 | 64.41 |
| Al₂O₃ | | 15.40 | 15.37 | 15.35 | 15.41 | 15.54 |
| P₂O₅ | | 1.51 | 1.73 | 1.95 | 1.16 | 1.18 |
| B₂O₃ | | 3.34 | 3.29 | 3.25 | 3.32 | 3.35 |
| MgO | | 0.52 | 0.53 | 0.52 | 0.52 | 0.51 |
| CaO | | 1.49 | 1.47 | 1.49 | 1.43 | 1.43 |
| SrO | | 1.06 | 1.02 | 1.00 | 1.07 | 1.06 |
| Li₂O | | 6.01 | 5.69 | 5.33 | 6.83 | 6.61 |
| Na₂O | | 5.69 | 6.02 | 6.34 | 5.27 | 5.28 |
| K₂O | | 0.56 | 0.68 | 0.80 | 0.41 | 0.40 |
| TiO₂ | | 0.17 | 0.17 | 0.17 | 0.16 | 0.16 |
| SnO₂ | | 0.05 | 0.05 | 0.05 | 0.05 | 0.06 |
| Fe₂O₃ | | 0.00 | 0.00 | 0.00 | 0.01 | 0.02 |
| Li₂O/Na₂O | | 1.06 | 0.95 | 0.84 | 1.29 | 1.25 |
| Al₂O₃ − R₂O − RO | | 0.07 | −0.04 | −0.13 | −0.12 | 0.25 |
| MgO + Li₂O − | | −2.27 | −2.97 | −3.78 | −0.83 | −1.05 |
| (CaO + SrO + Na₂O + K₂O) | | | | | | |
| Density (g/cm³) | | 2.414 | 2.415 | 2.414 | | |
| CTE 0-300° C. | | | | | | |
| (ppm/° C.) | | | | | | |
| Fiber | Strain Point | | | | | |
| Elongation | (° C.) | | | | | |
| | Annealing | | | | | |
| | Point | | | | | |
| | (° C.) | | | | | |
| | Softening | | | | | |
| | Point | | | | | |
| | (° C.) | | | | | |
| Young's Modulus | | | | | | |
| (GPa) | | | | | | |
| Shear Modulus | | | | | | |
| (GPa) | | | | | | |
| Poisson's ratio | | | | | | |
| CNSB | K_{IC} | | | | | |
| K_{IC} | (MPa · m^{0.5}) | | | | | |
| | St. | | | | | |
| | Deviation | | | | | |
| DCB | K_{IC} | | | | 0.812 | 0.782 |
| K_{IC} | (MPa · m^{0.5}) | | | | | |
| | St. | | | | 0.018 | 0.009 |
| | Deviation | | | | | |
| Refractive Index | | | | | | |
| Stress Optical Coefficient | | | | | | |
| VFT | A | −3.525 | −3.468 | −3.658 | −3.320 | −3.988 |
| Parameters | B | 9003.5 | 8937 | 9407.9 | 8565.3 | 9821.5 |
| | Tₒ | 64.7 | 71.1 | 46.5 | 87.9 | 28.6 |
| Liquidus | Air | 1095 | 1095 | 1085 | 1070 | 1100 |
| Temperature | Internal | 1090 | 1095 | 1080 | 1065 | 1085 |
| (° C.) | Platinum | 1080 | 1085 | 1075 | 1040 | 1090 |
| | Primary | Feldspar | Feldspar | Feldspar | Anorthoclase | Anorthoclase |
| | Phase | Solid- | Solid- | Solid- | | |
| | | Solution | Solution | Solution | | |
| | Secondary | | | | Spodumene | Spodumene |
| | Phase | | | | | |
| Liquidus | Air | 164 | 182 | 252 | 252 | 204 |
| Viscosity | Internal | 180 | 182 | 279 | | |
| (kP) | Platinum | 220 | 221 | 309 | | |

Substrates with a thickness of 0.6 mm and 0.7 mm were formed from Composition 1 (Table I), and subsequently ion exchanged to form example articles, corresponding to Articles DA and DB, respectively (Table II). Substrates with a thickness of 0.55 mm, 0.6 mm, 0.65 mm, and 0.7 mm were formed from Composition 9 (Table I), and subsequently ion-exchanged to form example articles (see Articles DC-DS and EA-EN for reported thickness and properties in Table II).

The substrates were subjected to a two-step ion exchange process, where the substrates were submerged in a first molten salt bath and then submerged in a second molten salt bath. To form Articles DA-DB, the first molten salt bath was at a temperature of 425° C. and the second molten salt bath was a temperature of 390° C., with the composition and ion exchange time for each bath reported in Table II. For Articles DC-DS, EA-EC, and EJ-EN, the first molten salt bath was maintained at either 440° C. or 450° C. and the second molten salt bath was maintained at either 390° C. or 400° C., with the composition and ion exchange time for each bath reported in Table II. For Articles ED-EI, the first molten salt bath was maintained at 400° C. and the second molten salt bath was maintained at 390° C. using Composition 9 and ion exchange time for each bath reported in Table II.

Table II also reports properties of the resulting stress profile, including the maximum compressive stress at the first major surface (CS_{surface}), the depth of the spike (DOLₛₚ), the stress at the DOLₛₚ (CSₛₚ), the depth of compression (DOC), and the maximum tensile stress in the central tension region (CT). The stress profile of article DA and DB of Table II were measured with RNF, as shown in FIGS. 6-7, respectively. In FIGS. 6-7, the horizontal axis 601 and 701 is a depth from the first major surface in micrometers (μm), the vertical axis 603 and 703 is the stress measured in MegaPascals (MPa), and curves 605 and 705 correspond to the stress profiles of articles DA and DB. The stress profile of article DD, DG, DJ, and DM of Table II were measured with RNF, as shown in FIG. 8. In FIG. 8, the horizontal axis 801 is a depth from the first major surface in micrometers (μm), the vertical axis 801 is the stress measured in MegaPascals (MPa), and curves 805, 807, 809, and 811 correspond to the stress profiles of articles DD, DG, DJ, and DM, respectively.

TABLE II

| Article | | DA | DB | DC | DD | DE | DF | DG |
|---|---|---|---|---|---|---|---|---|
| Composition | | 1 | 1 | 9 | 9 | 9 | 9 | 9 |
| Thickness (mm) | | 0.7 | 0.6 | 0.7 | 0.7 | 0.65 | 0.65 | 0.65 |
| IOX | KNO₃ (wt %) | 40 | 40 | 50 | 40 | 60 | 60 | 60 |
| Bath 1 | NaNO₃ (wt %) | 60 | 60 | 50 | 60 | 40 | 40 | 40 |
| | Time (h) | 3.0 | 2.4 | 2.6 | 2.7 | 1.7 | 1.6 | 2.0 |
| | Temp (° C.) | 425 | 425 | 440 | 440 | 440 | 440 | 440 |
| IOX | KNO₃ (wt %) | 98 | 99 | 99 | 99 | 99 | 99 | 99 |
| Bath 2 | NaNO₃ (wt %) | 2 | 1 | 1 | 1 | 1 | 1 | 1 |
| | Time (h) | 0.25 | 0.17 | 0.25 | 0.25 | 0.25 | 0.25 | 0.25 |
| | Temp (° C.) | 390 | 390 | 390 | 390 | 390 | 390 | 390 |

| | | | | | | | |
|---|---|---|---|---|---|---|---|
| CS_{surface} (MPa) | 880 | 960 | 1150 | 1190 | 1140 | 1150 | 1170 |
| CSₛₚ (MPa) | 172 | 174 | | 164 | | 160 | 186 |
| DOLₛₚ (um) | 6.5 | 4.1 | 7.2 | 6.5 | 5.9 | 5.9 | 6.0 |
| DOC (um) | 141 | 121 | | 137 | | 124 | 125 |
| CT (MPa) | 117.4 | 91.8 | 85.5 | 86.7 | 82.4 | 82.9 | 89.4 |
| CSₛₚ/CS_{surface} | 0.195 | 0.181 | | 0.138 | | 0.140 | 0.160 |
| DOLₛₚ/DOC | 0.046 | 0.034 | | 0.048 | | 0.048 | 0.048 |
| DOC/t | 0.201 | 0.201 | | 0.195 | | 0.191 | 0.192 |
| Spike Slope (MPa/μm) | | | | −157 | | −168 | −163 |
| Deep Slope (MPa/μm) | | | | −1.26 | | −1.36 | −1.57 |
| Stored Compression | 46.6 | 53.9 | | | | | |
| Energy (J/m²) | | | | | | | |
| Stored Tension Energy | 18.6 | 17.1 | | | | | |
| (J/m²) | | | | | | | |
| Total Stored Energy | 65.3 | 71.1 | | 70.4 | | 70.7 | 77.5 |
| (J/m²) | | | | | | | |

| Article | | DH | DI | DJ | DK | DL | DM |
|---|---|---|---|---|---|---|---|
| Composition | | 9 | 9 | 9 | 9 | 9 | 9 |
| Thickness (mm) | | 0.6 | 0.6 | 0.6 | 0.55 | 0.55 | 0.55 |
| IOX | KNO₃ (wt %) | 40 | 40 | 60 | 60 | 60 | 60 |
| Bath 1 | NaNO₃ (wt %) | 60 | 60 | 40 | 40 | 40 | 40 |
| | Time (h) | 1.7 | 1.6 | 1.9 | 1.5 | 1.6 | 1.9 |
| | Temp (° C.) | 440 | 440 | 440 | 450 | 450 | 450 |
| IOX | KNO₃ (wt %) | 100 | 99 | 100 | 99 | 99 | 100 |
| Bath 2 | NaNO₃ (wt %) | 0 | 1 | 0 | 1 | 1 | 0 |
| | Time (h) | 0.25 | 0.25 | 0.25 | 0.25 | 0.25 | 0.25 |
| | Temp (° C.) | 400 | 390 | 400 | 390 | 390 | 400 |

| | | | | | | |
|---|---|---|---|---|---|---|
| CS_{surface} (MPa) | 1270 | 1110 | 1270 | 1120 | 1180 | 1250 |
| CSₛₚ (MPa) | | | 136 | 145 | 171 | 140 |
| DOLₛₚ (μm) | 6.5 | 6.5 | 6.2 | 6.4 | 5.9 | 6.3 |
| DOC (μm) | | | 117 | 118 | 115 | 108 |
| CT (MPa) | 85.6 | 86.4 | 82.8 | 84.4 | 91.9 | 87.9 |
| CSₛₚ/CS_{surface} | | | 0.107 | 0.130 | 0.144 | 0.112 |
| DOLₛₚ/DOC | | | 0.053 | 0.054 | 0.051 | 0.058 |
| DOC/t | | | 0.194 | 0.196 | 0.192 | 0.197 |
| Spike Slope (MPa/μm) | | | −183 | −152 | −171 | −176 |
| Deep Slope (MPa/μm) | | | −1.23 | −1.30 | −1.56 | −1.38 |
| Stored Compression | | | | | | |
| Energy (J/m²) | | | | | | |
| Stored Tension Energy | | | | | | |
| (J/m²) | | | | | | |
| Total Stored Energy | | | 66.6 | 61.9 | 69.8 | 66.0 |
| (J/m²) | | | | | | |

| Article | | DN | DO | DP | DQ | DR | DS |
|---|---|---|---|---|---|---|---|
| Composition | | 9 | 9 | 9 | 9 | 9 | 9 |
| Thickness (mm) | | 0.55 | 0.55 | 0.55 | 0.55 | 0.55 | 0.55 |
| IOX | KNO₃ (wt %) | 60 | 60 | 60 | 60 | 80 | 80 |
| Bath 1 | NaNO₃ (wt %) | 40 | 40 | 40 | 40 | 20 | 20 |
| | Time (h) | 1.6 | 1.6 | 1.9 | 1.9 | 3.5 | 3.5 |
| | Temp (° C.) | 440 | 440 | 440 | 450 | 450 | 450 |
| IOX | KNO₃ (wt %) | 100 | 99 | 99 | 100 | 99 | 100 |
| Bath 2 | NaNO₃ (wt %) | 0 | 1 | 1 | 0 | 1 | 0 |
| | Time (h) | 0.25 | 0.25 | 0.25 | 0.25 | 0.25 | 0.25 |
| | Temp (° C.) | 400 | 390 | 390 | 400 | 390 | 400 |

| | | | | | | |
|---|---|---|---|---|---|---|
| CS_{surface} (MPa) | 1320 | 1160 | 1230 | 1300 | 1130 | 1310 |
| CSₛₚ (MPa) | 146 | 159 | 163 | | | |
| DOLₛₚ (um) | 6.0 | 5.9 | 5.8 | 5.9 | 5.7 | 5.7 |
| DOC (um) | 108 | 106 | 107 | | | |
| CT (MPa) | 92.2 | 93.3 | 90.1 | 92.3 | 86.0 | 82.4 |
| CSₛₚ/CS_{surface} | 0.129 | 0.121 | 0.140 | | | |
| DOLₛₚ/DOC | 0.056 | 0.0565 | 0.551 | | | |
| DOC/t | 0.196 | 0.193 | 0.195 | | | |
| Spike Slope (MPa/μm) | −162 | −194 | −168 | | | |
| Deep Slope (MPa/μm) | −1.44 | −1.59 | −1.61 | | | |
| Stored Compression | | | | | | |
| Energy (J/m²) | | | | | | |
| Stored Tension Energy | | | | | | |
| (J/m²) | | | | | | |
| Total Stored Energy | 59.2 | 70.2 | 55.5 | | | |
| (J/m²) | | | | | | |

| Article | | EA | EB | EC | ED | EE | EF | EG |
|---|---|---|---|---|---|---|---|---|
| Composition | | 9 | 9 | 9 | 9 | 9 | 9 | 9 |
| Thickness (mm) | | 0.55 | 0.55 | 0.55 | 0.55 | 0.55 | 0.55 | 0.55 |
| IOX | KNO₃ (wt %) | 60 | 60 | 60 | 60 | 60 | 60 | 60 |
| Bath 1 | NaNO₃ (wt %) | 40 | 40 | 40 | 40 | 40 | 40 | 40 |
| | Time (h) | 1.6 | 1.6 | 1.6 | 3.0 | 3.0 | 3.0 | 3.0 |
| | Temp (° C.) | 450 | 450 | 450 | 400 | 400 | 400 | 400 |
| IOX | KNO₃ (wt %) | 94 | 93 | 92 | 99 | 94 | 98 | 93 |
| Bath 2 | NaNO₃ (wt %) | 1 | 2 | 3 | 1 | 1 | 2 | 2 |
| | K₂CO₃ (wt %) | 5 | 5 | 5 | 0 | 5 | 0 | 5 |
| | Time (h) | 0.25 | 0.25 | 0.25 | 0.25 | 0.25 | 0.25 | 0.25 |
| | Temp (° C.) | 390 | 390 | 390 | 390 | 390 | 390 | e90 |

| | | | | | | | |
|---|---|---|---|---|---|---|---|
| CS_{surface} (MPa) | 1120 | 980 | 870 | 1285 | 1180 | 1030 | 1120 |
| CSₛₚ (MPa) | 169 | 159 | 159 | | 180 | 184 | 188 |
| DOLₛₚ (um) | 6.0 | 6.8 | 7.2 | 3.6 | 3.6 | 3.9 | 3.7 |
| DOC (um) | 108 | 108 | 106 | | 104 | 106 | 106 |
| CT (MPa) | 92.6 | 90.4 | 88.0 | 90.7 | 88.7 | 87.3 | 89.2 |
| CSₛₚ/CS_{surface} | 0.158 | 0.162 | 0.183 | | 0.153 | 0.179 | 0.168 |
| DOLₛₚ/DOC | 0.056 | 0.063 | 0.068 | | 0.035 | 0.037 | 0.035 |
| DOC/t | 0.196 | 0.196 | 0.193 | | 0.189 | 0.193 | 0.193 |
| Spike Slope (MPa/μm) | −158 | −121 | −100 | | −280 | −216 | −256 |
| Deep Slope (MPa/μm) | −1.65 | −1.57 | −1.60 | | −1.78 | −1.81 | −1.84 |
| Stored Compression | | | | | | | |
| Energy (J/m²) | | | | | | | |
| Stored Tension Energy | | | | | | | |
| (J/m²) | | | | | | | |
| Total Stored Energy | 63.8 | 57.2 | 55.6 | | | 58.5 | 63.0 |
| (J/m²) | | | | | | | |

| Article | | EH | EI | EJ | EK | EL | EM | EN |
|---|---|---|---|---|---|---|---|---|
| Composition | | 9 | 9 | 9 | 9 | 9 | 9 | 9 |
| Thickness (mm) | | 0.55 | 0.55 | 0.55 | 0.55 | 0.55 | 0.55 | 0.55 |
| IOX | KNO₃ (wt %) | 60 | 60 | 60 | 60 | 60 | 60 | 60 |
| Bath 1 | NaNO₃ (wt %) | 40 | 40 | 40 | 40 | 40 | 40 | 40 |
| | Time (h) | 3.0 | 3.0 | 1.6 | 1.6 | 1.9 | 1.9 | 1.5 |
| | Temp (° C.) | 400 | 400 | 450 | 450 | 440 | 440 | 400 |
| IOX | KNO₃ (wt %) | 92 | 97 | 90 | 90 | 98 | 97 | 98 |
| Bath 2 | NaNO₃ (wt %) | 3 | 3 | 5 | 5 | 2 | 3 | 2 |
| | K₂CO₃ (wt %) | 5 | 0 | 5 | 5 | 0 | 0 | 0 |
| | Time (h) | 0.25 | 0.25 | 0.25 | 0.25 | 0.25 | 0.25 | 0.25 |
| | Temp (° C.) | 390 | 390 | 390 | 390 | 400 | 400 | 400 |

| | | | | | | | |
|---|---|---|---|---|---|---|---|
| CS_{surface} (MPa) | 1095 | 880 | 860 | 960 | 1010 | 930 | 1025 |
| CSₛₚ (MPa) | 188 | 190 | 162 | 151 | | 172 | 171 |
| DOLₛₚ (μm) | 3.7 | 5.5 | 8.1 | 7.8 | 6.1 | 6.4 | 3.3 |
| DOC (μm) | 104 | 105 | 109 | 111 | | 109 | 97 |
| CT (MPa) | 87.3 | 90.0 | 92.9 | 91.0 | 95.6 | 92.1 | 74.6 |
| CSₛₚ/CS_{surface} | 0.172 | 0.216 | 0.188 | 0.157 | | 0.185 | 0.167 |
| DOLₛₚ/DOC | 0.036 | 0.052 | 0.074 | 0.070 | | 0.059 | 0.034 |
| DOC/t | 0.189 | 0.191 | 0.198 | 0.202 | | 0.198 | 0.176 |
| Spike Slope (MPa/μm) | −243 | −126 | −99 | −105 | | −118 | −259 |
| Deep Slope (MPa/μm) | −1.87 | −1.91 | −1.61 | −1.46 | | −1.68 | −1.81 |
| Stored Compression | | | | | | | |
| Energy (J/m²) | | | | | | | |
| Stored Tension Energy | | | | | | | |
| (J/m²) | | | | | | | |
| Total Stored Energy | 60.7 | 57.0 | 56.5 | 51.5 | | 60.7 | 54.6 |
| (J/m²) | | | | | | | |

Article DA comprised a thickness of 0.7 mm, and Article DB comprised a thickness of 0.6 mm. The glass-based substrates were subjected to ion exchange in a first molten salt bath with a composition of 60 wt % NaNO₃ and 40 wt % KNO₃, at a temperature of 425° C., for times ranging from 2 hours to 3 hours, followed by ion exchange in a second molten salt bath with a composition of 2 wt % NaNO₃ and 98 wt % KNO₃, at a temperature of 390° C., for times ranging from 0.1 hours to 0.25 hours. As shown in FIGS. 6-7 and in Table 11, Articles DA and DB comprised a maximum compressive stress from 850 MPa to 1,000 MPa, a depth of the spike (DOLₛₚ) from 3 μm to 10 μm, the stress at the DOLₛₚ (CSₛₚ) from 150 MPa to 200 MPa, the depth of compression (DOC) from 110 μm to 150 μm, and the maximum tensile stress in the central tension region (CT) from 80 MPa to 120 MPa. As further shown in Table II for Articles DA and DB, the stored compression energy ranged from 40 J/m² to 60 J/m², a stored tension energy ranged from 15 J/m² to 20 J/m², and the total stored energy ranges from 60 J/m² to 75 J/m². Also, Articles DA and DB comprised a CSₛₚ/CS_{surface} from 0.18 to about 0.25 (e.g., from 0.18 to 0.21) and DOLₛₚ/DOC from 0.02 to 0.05 (e.g., from 0.03 to 0.05), which can be a distinctive characteristic of the compositions of the present disclosure. Additionally, samples of Article DA exhibited a Knoop Scratch Threshold from 10 N to 13 N. Samples of Article DA withstood an average height of 148 cm in the Flat Face Drop Test, and samples of Article DB withstood an average height of 132 cm glass-based article can withstand a height in the Flat Face Drop.

Articles DC-DD comprised a thickness of 0.7 mm, Articles DE-DG comprised a thickness of 0.6 mm, and Articles DH-DS comprised a thickness of 0.55 mm. The glass-based substrates were subjected to ion exchange in a first molten salt bath with a composition of from 40 wt % to 60 wt % NaNO₃ and 40 wt % to 60 wt % KNO₃, at a temperature of 440° C. or 450° C., for times ranging from 1.5 hours to 3.5 hours, followed by ion exchange in a second molten salt bath with a composition of 0 wt % to 1 wt % NaNO₃ and 99 wt % to 100 wt % KNO₃, at a temperature of 390° C. or 400° C., for 0.25 hours. As shown in Table II, Articles DC-DS comprised a maximum compressive stress from 1,100 MPa to 1,350 MPa, a depth of the spike (DOLₛₚ) from 5 μm to 10 μm, the stress at the DOLₛₚ (CSₛₚ) from 130 MPa to 200 MPa, the depth of compression (DOC) from 105 μm to 150 μm, and the maximum tensile stress in the central tension region (CT) from 80 MPa to 95 MPa. As further shown in Table II for Articles DC-DS, the total stored compression energy ranged from 55 J/m² to 75 J/m². Also, Articles DC-DS comprised a CSₛₚ/CS_{surface} from 0.105 to about 0.16 and DOLₛₚ/DOC from 0.04 to 0.06, which can be a distinctive characteristic of the compositions of the present disclosure.

As shown in Table II, Articles EA-EN were subjected to ion exchange in a first molten salt bath comprising 60 wt % KNO₃ and 40 wt % NaNO₃ maintained at from 400° C. to 450° C. for from 1.5 hours to 3.0 hours, followed by ion exchange in a second molten salt bath with a composition of 92 wt % to 99 wt % KNO₃, 1 wt % to 5 wt % NaNO₃, and (optionally) 0 wt % to 5 wt % K₂CO₃ maintained at from 390° C. to 400° C. for 0.25 hours. As shown in Table II, Articles EA, ED, EE, and EG comprised a maximum compressive stress from 1,100 MPa to 1,350 MPa; Articles EA-EC and EI-EL comprised a depth of the spike (DOLₛₚ) from 5 μm to 10 μm; Articles EA-EC, EE-EK, and EM-EN comprised a stress at the DOLₛₚ (CSₛₚ) from 130 MPa to 200 MPa; Articles EA-EC, EF-EG, EI-EK, and EN-EM comprised a depth of compression (DOC) from 105 μm to 150 μm; and Articles EA-EN comprised a maximum tensile stress in the central tension region (CT) from 80 MPa to 95 MPa. Also, Article EA comprised a maximum compressive stress from 1,100 MPa to 1,350 MPa, a depth of the spike (DOLₛₚ) from 5 μm to 10 μm, a stress at the DOLₛₚ (CSₛₚ) from 130 MPa to 200 MPa, a depth of compression (DOC) from 105 μm to 150 μm, and a maximum tensile stress in the central tension region (CT) from 80 MPa to 95 MPa. As further shown in Table II for Articles EA-EC, EF-EJ, and EM, the total stored compression energy ranged from 55 J/m² to 75 J/m². Also, Articles EA and ED comprised a CSₛₚ/CS_{surface} from 0.105 to about 0.16 and DOLₛₚ/DOC from 0.04 to 0.06, which can be a distinctive characteristic of the compositions of the present disclosure. Regarding, the effect of K₂CO₃, Articles EE, EG, and EH will be compared with Examples ED, EF, and EI, respectively, that are all chemically strengthened in the same first molten salt bath (and associated treatment conditions) and the same time and temperature for the second molten salt bath treatment with either 0 wt % K₂CO₃ or 5 wt % K₂CO₃. For pairs of Articles EG versus EF and EH versus EI, the addition of 5 wt % K₂CO₃ is associated with increases in CS_{surface}, magnitude (i.e., absolute value) of the spike slope, and total stored energy as well as a decrease in DOLₛₚ, CSₛₚ/CS_{surface}, and DOLₛₚ/DOC.

Volume resistivity was also measured for Composition 1 (no ion exchange) and for article DA (prepared as described in Table II). The volume resistivity of Composition 1 (no ion exchange) was 1.4×10¹⁶ Ω-cm, and the volume resistivity of article DA (prepared as described in Table II) was 1.7×10¹⁶ Ω-cm.

The above observations can be combined to produce lithium aluminosilicate glasses with good ion exchangeability, good glass quality, and high fracture toughness. Chemical strengthening processes can be used to achieve high strength and high toughness properties in lithium aluminosilicate glasses. The substitution of Al₂O₃ into the silicate glass network increases the interdiffusivity of monovalent cations during ion exchange. By chemical strengthening in a molten salt bath (e.g., KNO₃ or NaNO₃), glasses with high strength, high toughness, and high indentation cracking resistance can be achieved. The stress profiles achieved through chemical strengthening may have a variety of shapes that increase the drop performance, strength, toughness, and other attributes of the glass-based articles.

The glasses described herein can achieve high fracture toughness values (e.g., at least 0.75 MPa√m) without the inclusion of additives, such as ZrO₂, Ta₂O₅, TiO₂, HfO₂, La₂O₃, and Y₂O₃, that increase the fracture toughness but are expensive and may have limited commercial availability. In this respect, the glasses disclosed herein provide comparable or improved performance with reduced manufacturing costs. Fracture toughness and stress at depth are critical for improved drop performance on rough surfaces. For this reason, maximizing the amount of stress that can be provided in a glass-based article before reaching a frangibility limit increases the stress at depth and the rough surface drop performance. The fracture toughness is known to control the frangibility limit and increasing the fracture toughness increases the frangibility limit. The glass-based compositions disclosed herein have a high fracture toughness and are capable of achieving high compressive stress levels while remaining non-frangible. These characteristics of the glass-based compositions enable the development of improved stress profiles designed to address particular failure modes. This capability allows the ion-exchanged glass-based articles produced from the glass-based compositions described herein to be customized with different stress profiles to address particular failure modes of concern.

The compositions described herein are selected to achieve high fracture toughness values while also maintaining a desired degree of manufacturability. The compositions include high amounts of Al₂O₃ and Li₂O to produce a desired fracture toughness while maintaining compatibility with desired manufacturing limits. The drop performance of ion-exchanged glass-based articles formed from the glass-based compositions described herein is improved by increasing the depth of compression (DOC), which may be achieved at least in part by selecting a high Li/Na molar ratio (e.g., from 1.2 to 2). The glass-based compositions described herein provide improved ion exchange performance, as evidenced by an increased central tension capability and increased ion exchange speed, while also avoiding volatility issues at free surfaces during manufacturing that may be introduced by B₂O₃ and P₂O₅ contents that are too high, when the concentration of Al₂O₃ is balanced against the concentration of SiO₂ and the concentration of alkali oxides in the glass-based composition, Al₂O₃ can reduce the liquidus temperature of the glass melt, thereby enhancing the liquidus viscosity and improving the compatibility of the glass-based composition with certain forming processes.

Contrary to the conventional expectation that lower liquidus viscosity has been associated with higher K_{IC} values and improved ion exchange capability, the Examples of the present disclosure demonstrate that a high fracture toughness (e.g., K_{IC} of 0.75 MPa√m or more) can be obtained simultaneously with a high liquidus viscosity (e.g., 100 kP or more, 150 kP or more, 175 kP or more, or from 200 kP to 300 kP). Without wishing to be bound by theory, it is believed that compositions of the present disclosure produced a different structure of the glass network that is associated with a non-spodumene crystal phase when the composition is crystalized. Without wishing to be bound by theory, it is believed that when a value of MgO+Li₂O−(CaO+SrO+Na₂O+K₂O) (in mol %) is slightly negative (e.g., from −4 to −0.5 or from −1.5 to −1), the glass-based composition may crystallize into a non-spodumene primary crystal phase that can be associated with increased liquidus viscosity (e.g., 100 kP or more, 150 kP or more, 175 kP or more, from 200 kP to 300 kP).

Providing RO can increase a volume resistivity of the resulting glass-based substrate and/or glass-based article, for example, because of the relatively high field strength of alkaline earth metal ions and/or decreasing a mobility of alkali metal ions. Providing glass-based substrates and/or glass-based articles with a high volume electrical resistivity (e.g., 2×10¹⁵ Ohm-centimeters or more, or from 1×10¹⁶ Ohm-centimeters to 1×10¹⁷ Ohm-centimeters) can decrease an incidence of electrostatic discharge that can discolor or otherwise damage glass-based substrates and/or glass-based articles, especially when the dimensions of the glass-based substrate and/or glass-based article is larger (e.g., 10 cm or more, or 20 cm or more).

Through different ion exchange processes, greater central tension (CT), depth of compression (DOC), and high compressive stress (CS) can be achieved. However, the addition of lithium in the aluminosilicate glass may reduce the melting point, softening point, or liquidus viscosity of the glass. By providing a glass-based substrate and/or a ceramic-based substrate comprising a first depth of compression and/or a second depth of compression in a range from about 20% to about 25% of the substrate thickness, good impact and/or puncture resistance can be enabled. The values of the ratio of the depth of layer (e.g., DOL_{SP}) to the depth of compression (e.g., DOC) (e.g., from 0.08 to 0.25 or from 0.18 to 0.25) in combination with the ratio of the compressive stress at the depth of the compressive stress spike to the corresponding maximum compressive stress (e.g., from 0.02 to 0.05) can be a characteristic of the compositions of the present disclosure, which may be distinctive from other compositions.

All compositional components, relationships, and ratios described in this specification are provided in mol % unless otherwise stated. All ranges disclosed in this specification include any and all ranges and subranges encompassed by the broadly disclosed ranges whether or not explicitly stated before or after a range is disclosed.
also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A glass-based article comprising a composition, based on an oxide basis of the glass-based article, comprising:
from greater than or equal to 60 mol % to less than or equal to 69 mol % SiO₂;
from greater than or equal to 10 mol % to less than or equal to 18 mol % Al₂O₃;
from greater than or equal to 2.3 mol % to less than or equal to 6.9 mol % Li₂O;
from greater than or equal to 2.1 mol % to less than or equal to 6.7 mol % Na₂O;
from greater than or equal to 0.25 mol % to less than or equal to 1 mol % K₂O; and
from greater than or equal to 1.1 mol % to less than or equal to 9 mol % RO, where RO is a sum of amounts of MgO, CaO, SrO, BaO, and ZnO,
wherein a liquidus viscosity of the composition is greater than or equal to 150 kiloPoise.

2. The glass-based article of claim 1, wherein the liquidus viscosity is greater than or equal to 175 kiloPoise.

3. The glass-based article of claim 1, wherein the composition crystalizes to have a primary crystal phase comprising anorthoclase or a feldspar solid solution after being heated at 1050° C. for 24 hours.

4. The glass-based article of claim 1, wherein a value of MgO+Li₂O−(CaO+SrO+Na₂O+K₂O) in mol % is from greater than or equal to −4 to less than or equal to −0.5.

5. The glass-based article of claim 1, wherein the composition comprises:
from greater than or equal to 10 mol % to less than or equal to 16 mol % Al₂O₃;
greater than or equal to 0.5 mol % to P₂O₅; and
from greater than or equal to 0.5 mol % to less than or equal to 3.6 mol % B₂O₃.

6. The glass-based article of claim 1, wherein the composition comprises:
from greater than or equal to 2 mol % to less than or equal to 3.6 mol % B₂O₃.

7. The glass-based article of claim 1, wherein a volume electrical resistivity is greater than or equal to 2×10¹⁵ Ohm-centimeters.

8. The glass-based article of claim 1, wherein the composition comprises:
from greater than or equal to 60 mol % to less than or equal to 66 mol % SiO₂;
from greater than or equal to 14 mol % to less than or equal to 16 mol % Al₂O₃;
from greater than or equal to 5 mol % to less than or equal to 6.9 mol % Li₂O;
from greater than or equal to 4 mol % to less than or equal to 6 mol % Na₂O;
from greater than or equal to 0.5 mol % to less than or equal to 3 mol % P₂O₅; and
from greater than 0 mol % to less than or equal to 1 mol % TiO₂.

9. The glass-based article of claim 1, wherein the composition comprises:
from greater than or equal to 6 mol % to less than or equal to 6.7 mol % Li₂O; and
from greater than or equal to 5 mol % to less than or equal to 5.8 mol % Na₂O.

10. The glass-based article claim 1, wherein:
a molar ratio of Li₂O/Na₂O is from greater than or equal to 1.2 to less than or equal to 2.1.

11. The glass-based article of claim 1, wherein the glass-based article is substantially free of Ta₂O₅, HfO₂, La₂O₃, Y₂O₃, ZnO, and ZrO₂.

12. The glass-based article of claim 1, further comprising:
from greater than or equal to 0.1 mol % to less than or equal to 0.5 mol % TiO₂; and
from greater than or equal to 0.1 mol % to less than or equal to 1 mol % K₂O.

13. The glass-based article of claim 1, wherein the composition comprises:
from greater than or equal to 1.5 mol % to less than or equal to 3.3 mol % RO.

14. The glass-based article of claim 1, wherein the composition comprises:
from greater than or equal to 0.1 mol % to less than or equal to 0.9 mol % MgO.

15. The glass-based article of claim 1, wherein the composition comprises:
from greater than or equal to 0.6 mol % to less than or equal to 1.5 mol % SrO.

16. The glass-based article of claim 1, wherein the glass-based article has a K_{IC} fracture toughness greater than or equal to 0.75 MPa·m^{0.5}.

17. The glass-based article of claim 1, further comprising:
a compressive stress layer extending from a surface of the glass-based article to a depth of compression, the compressive stress layer comprising a maximum compressive stress; and
a central tension region comprising a maximum central tension,
wherein the composition corresponds to a material at a center of the glass-based article, and the glass-based article comprises a thickness t, and the maximum compressive stress of the compressive stress layer is from greater than or equal to 500 MPa to less than or equal to 1500 MPa.

18. The glass-based article of claim 17, wherein the compressive stress layer comprises a compressive stress spike extending from the surface of the glass-based article to a depth of the compressive stress spike, and a ratio a compressive stress at the depth of the compressive stress spike to the maximum compressive stress is from greater than or equal to 0.08 to less than or equal to 0.25.

19. The glass-based article of claim 17, wherein the compressive stress layer comprises a compressive stress spike extending from the surface of the glass-based article to a depth of the compressive stress spike, and the depth of the compressive stress spike is from greater than or equal to 3 μm to less than or equal to 10 μm, and a stress in the depth of the compressive stress spike is less than or equal to 210 MegaPascals.

20. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover substrate disposed over the display,
wherein at least a portion of at least one of the housing and the cover substrate comprises the glass-based article of claim 1.
